(19) United States
(12) Patent Application Publication
(10) Pub. No.: US 2026/0118971 A1
(43) Pub. Date: Apr. 30, 2026

(54) SYSTEMS AND METHODS FOR KEYBOARD CHARACTER CREATION USING A MAXIMUM OF THREE KEYSTROKES

(71) Applicant: Aberra MOLLA, Brighton, CO (US)

(72) Inventor: Aberra MOLLA, Brighton, CO (US)

(21) Appl. No.: 18/867,379

(22) PCT Filed: May 19, 2023
(86) PCT No.: PCT/US2023/067258

§ 371 Date: Nov. 19, 2024

Related U.S. Application Data
(60) Provisional application No. 63/343,838, filed on May 19, 2022.

(51) Int. Cl. G06F 3/023

(52) U.S. Cl. CPC G06F 3/0235

(57) ABSTRACT

Systems and methods are disclosed that make an increased number of keys available for typing, such as for Ethiopic typing. In some embodiments, a complete set of characters or glyphs associated with a particular phonetic language can be typed using a maximum of three keystrokes on a QWERTY keyboard.

### CROSS REFERENCE TO RELATED APPLICATIONS

The present application claims the benefit of and priority, under 35 U.S.C. § 119 (e), to U.S. Provisional Application Ser. No. 63/343,838, filed on May 19, 2022, entitled “STANDARD ETHIOPIC KEYBOARD,” which is hereby incorporated by reference, in its entirety, for all that it teaches and for all purposes.

### FIELD

The present disclosure is generally directed to keyboards and, in particular, toward typing characters on QWERTY and similar layout keyboards.

### BACKGROUND

Since the introduction of foreign fonts to computers in 1982, numerous methods have been presented in an attempt to render characters in non-English languages (e.g., Ge'ez) using physical keyboards and, more recently, virtual keyboards—such as those implemented on smartphones. In some rendering editors or programs, vowels like “ [symbol] ” require four keystrokes on the keyboard to be generated, while “ [symbol] ” needs six keystrokes. As another example, typing the character “ [symbol] ” also needs six keystrokes. In some cases, there is no guarantee that the editor or program will determine that the glyph has been settled (e.g., there is no guarantee that the computer will recognize the character as completed, leading to the possibility that further keystrokes and further edit of the character are needed while such further edits are undesired). As an example of failure to settle the glyph, the word “ [symbol] ” (which includes two glyphs) can be typed with seven keystrokes, but if the user places the cursor between the two glyphs and an “E” is typed with “shift e”, the word is changed to “ [symbol] ” because the “ [symbol] ” was typed, but never settled. In other words, the computer failed to recognize that the “ [symbol] ” glyph as not requiring further modification. Furthermore, adding as “E” after the “ [symbol] ” may fail to change the glyph. Such issues may appear in both physical keyboards, as well as keyboards virtually rendered to the screens of smartphones.

In some cases, a user may desire to be able to type more than one language using the same keyboard. For example, the user may wish to use an Amharic set of characters, as well as characters from the Ge'ez language or the whole Ethiopic language. In such cases, current art related methods may fail to enable the user to access characters from multiple different languages.

The principle on which Ethiopic typing is based is rendering and settling the most commonly used Ethiopic glyph with a keystroke each, just like the Latin system. In some related art methods, the 37 primary or first order glyphs were given a key name each just like the Latin system. The default position was given to the Latin small alphabet because it was the most commonly used alphabet. Similarly and in other cases, the 37 keys of the keyboard were given to the sixth order Ethiopic because they were the most commonly used Ethiopic with similar sound like the English. Unfortunately, this makes it more difficult to write characters in Ethiopic languages because of dependence on the Latin keyboard keys; Ethiopic includes a large number of Ge'ez characters in its character set, making it difficult to create glyphs or characters while using a standard keyboard.

Most of these keyboard input methods require the user to know and memorize spelling of a huge number of sequences necessary to type. There is a need to develop more intuitive keyboarding and, if possible, reduce the number of key presses by the users. At the same time there is a need to utilize only the keyboard keys around the “a” to “z” keys.

### SUMMARY

Deficiencies in the art are addressed by embodiments of the present disclosure. Embodiments discussed herein involve the use of fewer keys to generate and settle glyphs or characters, while also accommodating more than one way to type a glyph with one to three keystrokes. In some embodiments, command keys such “Tab”, “Caps Lock”, “Ctrl” and even second “slash” keys may be available for use. Additionally, embodiments of the present disclosure implement Ethiopic numeral typing.

An improved Ethiopic typing system where defaults are typed with one and the rest with a maximum of two and/or three keystrokes to render and settle a glyph is described. The method is uniform across platforms and operating systems that vary from usages in computers, smartphones, laptops and the like. It also applies similarly in keyboards such as QWERTY, Hele ( [symbol] ) or other layouts in computers, smartphones and the like including abbreviated, virtual, custom or on-screen. Typing can be achieved through the use of fingers as well as methods that mimic it and vary from mouse clicks to external keyboards. More than one typing method and layout can be used from a keyboard and timeout and disable keys are optional. The purpose is to incorporate Ethiopic in any application that allow the usage of the font or typeface and include coding key sequences that may or may not result in the appearances of all on the screen.

In one method, typing is limited around the “F” and “J” home keys in computers and virtual keyboards without eliminating older methods. The default keys are utilized to render such single characters each that include vowel keys such as “ [symbol] ”, “ [symbol] ”, “ [symbol] ”, “ [symbol] ”, “ [symbol] ”, “ [symbol] ”, “ [symbol] ”, “ [symbol] ” and “ [symbol] ” as well as the number, numeric and command keys. The shifted forms of the vowels are also similarly dedicated similarly. Symbols on the numeric pad also type a glyph each from single keystrokes or more.

In one method a character is rendered with one to three keystrokes such that the glyph is settled with second activity involving programming of the sequences and the typeface. In another the activities are performed in the reverse direction with the same end results provided they do not interfere with the typing. Glyphs rendered with one or two keystrokes are also rendered and settled with non-printable glyphs just like the single keystroke varieties. There is thus no need to utilize more than three keystrokes to type and render Ethiopic and similar number of glyphs. Long holds and appearance of glyphs in a row showing the glyphs or just highlighting the choices can also be optional. The point here is to incorporate what others have tried and correct them with the new features.

The present disclosure describes methods of expanding the keyboard for many languages and the breakthrough is really worth celebrating. The present disclosure expands on the number of glyphs that can be typed by improving the functionality of the keys. Apart from characters on the number keys, the instant system may have additional row of characters at the bottom as before.

The method includes a dedicated Ethiopic and English publisher with numerous features Ethiopic needs and are too numerous to describe here.

The method also introduced an independent virtual “#=+” key that in the past appeared secondary to striking the “123” key for Latin keyboards such as English.

### BRIEF DESCRIPTION OF THE DRAWINGS

FIG. 1 shows an Amharic Computer Keyboard QWERTY Layout in accordance with embodiments of the present disclosure;

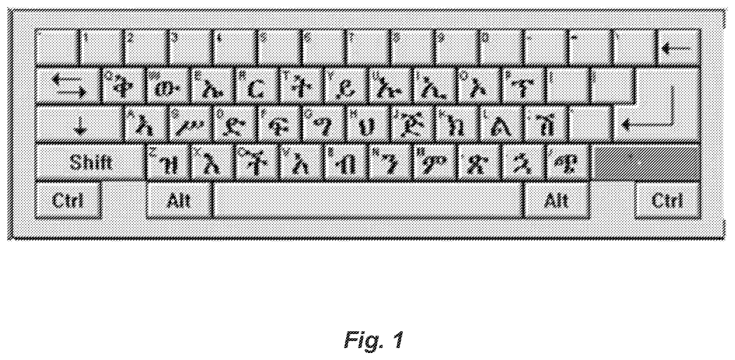

FIG. 2 shows an Ethiopic Computer Keyboard showing some non-default glyphs in accordance with embodiments of the present disclosure;

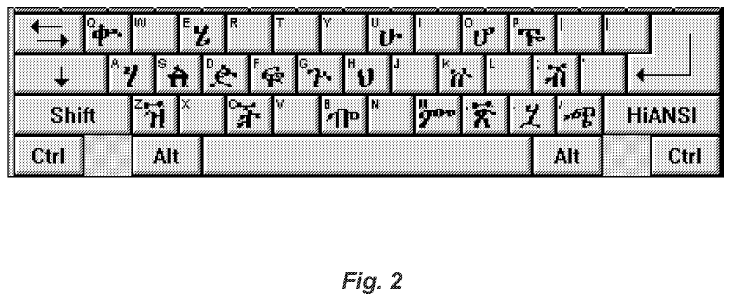

FIG. 3 shows optional glyphs assigned to the number keys in accordance with embodiments of the present disclosure;

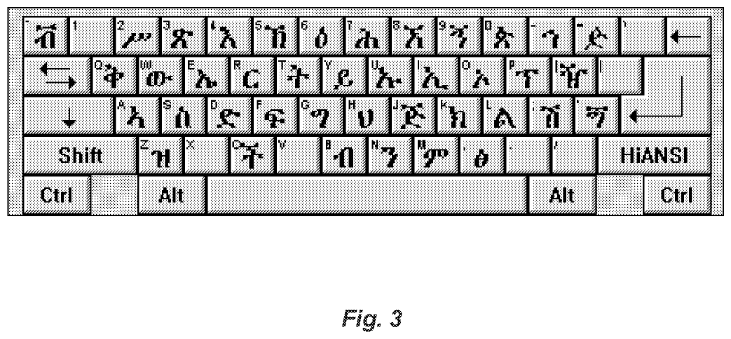

FIG. 4 shows a computer Amharic layout with the eight vowel keys in accordance with embodiments of the present disclosure;

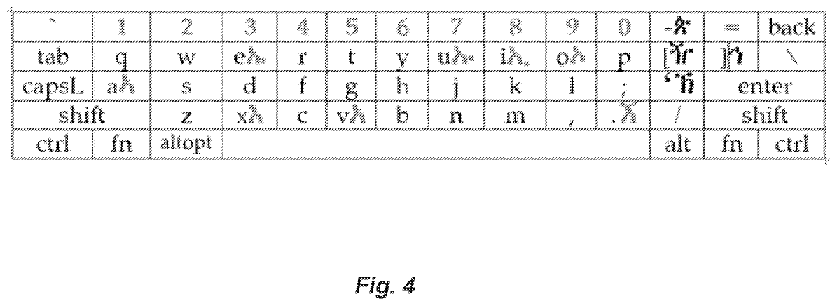

FIG. 5 shows a computer Amharic layout with default glyph typed with a keystroke each in accordance with embodiments of the present disclosure;

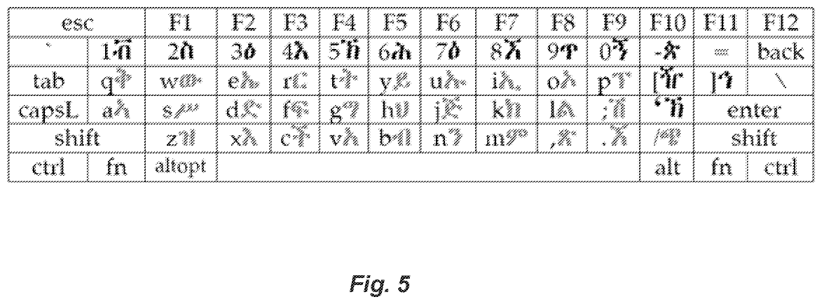

FIG. 6 shows a computer Amharic layout with some shifted glyphs typed with two keystrokes each in accordance with embodiments of the present disclosure;

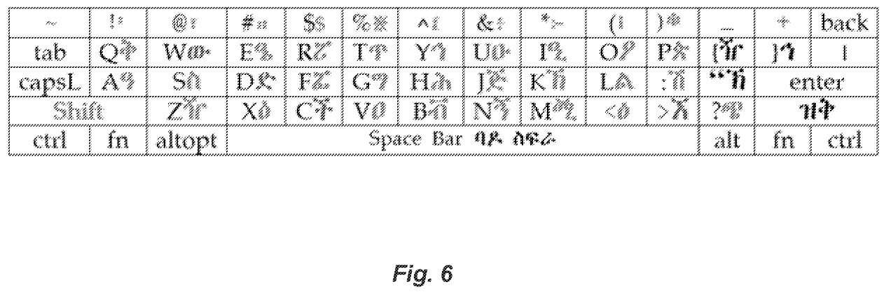

FIG. 7 shows a computer Amharic layout with numbers typed with the “depressed tab” (“ [symbol] ”) first keystrokes in accordance with embodiments of the present disclosure;

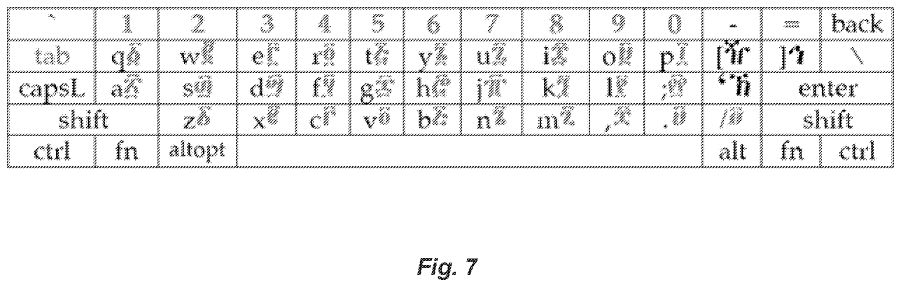

FIG. 8 shows a computer Amharic layout with symbols typed with glyphs and number keys in accordance with embodiments of the present disclosure;

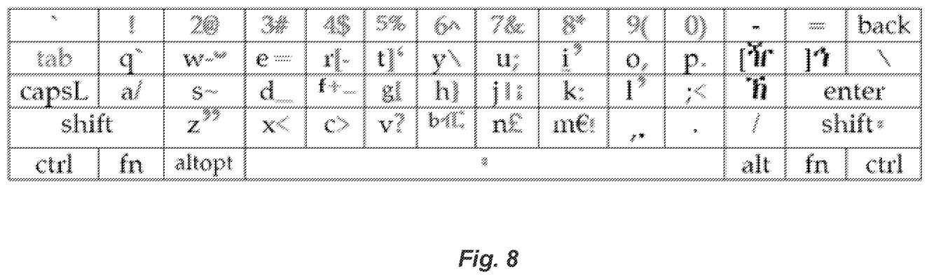

FIG. 9 shows computer Ethiopic layouts typed from the number second keystroke in accordance with embodiments of the present disclosure;

FIG. 10 shows a computer Ethiopic layout with some shared keys typed with the vowels, shifted vowels and numbers in accordance with embodiments of the present disclosure;

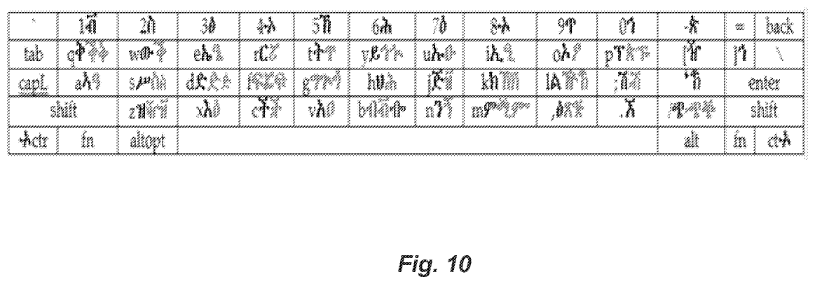

FIG. 11 shows an optional numeric keypad in accordance with embodiments of the present disclosure;

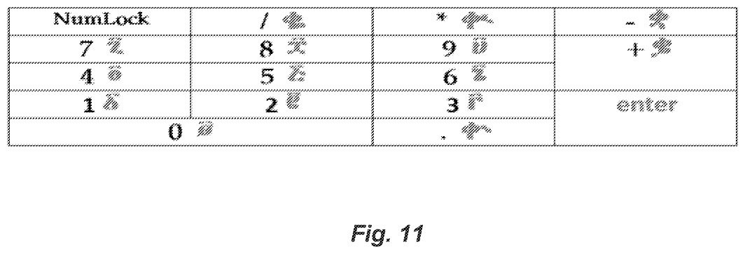

FIG. 12 shows a Smartphone layout with the eight vowel keys in accordance with embodiments of the present disclosure;

FIG. 13 shows a Smartphone layout with default glyph typed with a keystroke each in accordance with embodiments of the present disclosure;

FIG. 14 shows a Smartphone Amharic layout with some shifted glyphs typed with two keystrokes each in accordance with embodiments of the present disclosure;

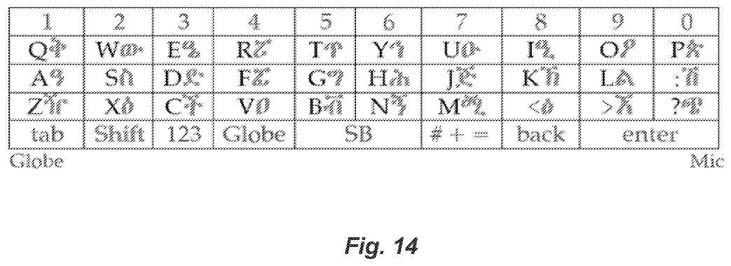

FIG. 15 shows a Smartphone Amharic+layout with shifted glyphs typed with two keystrokes each in accordance with embodiments of the present disclosure;

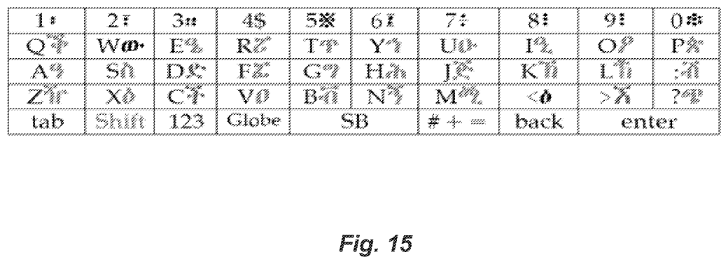

FIG. 16 shows a Smartphone symbols typed with glyphs and numbers in accordance with embodiments of the present disclosure;

FIG. 17 shows a Smartphone some glyph assignments typing with “6” in accordance with embodiments of the present disclosure;

FIG. 18 shows a Smartphone Ethiopic in accordance with embodiments of the present disclosure;

FIG. 19 shows a Smartphone Hele layout example in accordance with embodiments of the present disclosure;

FIG. 20 shows a Smartphone default English in accordance with embodiments of the present disclosure;

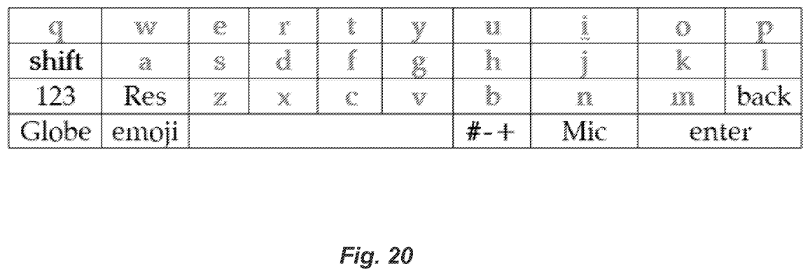

FIG. 21 shows a Smartphone shift English in accordance with embodiments of the present disclosure;

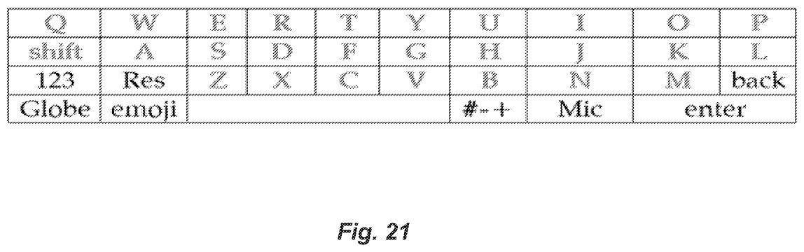

FIG. 22 shows a Smartphone “123” English in accordance with embodiments of the present disclosure;

FIG. 23 shows a Smartphone “#-+” English in accordance with embodiments of the present disclosure;

FIG. 24 shows a virtual key “#=+” to appear on the default keyboard eliminating an unnecessary extra keystroke in accordance with embodiments of the present disclosure;

FIG. 25 shows an example layout in accordance with embodiments of the present disclosure;

FIG. 26 shows an example key sequence assignment in GeezEdit and EthioSuite in accordance with embodiments of the present disclosure;

FIG. 27 shows an example of smartphone Ethiopic to be modified in accordance with embodiments of the present disclosure;

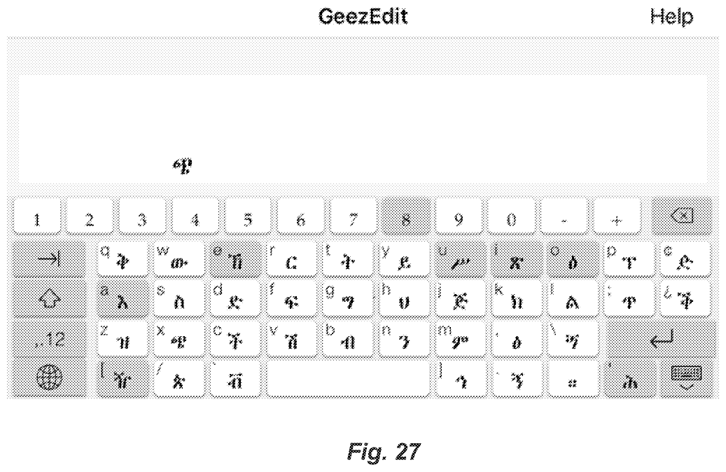

FIG. 28 shows a GeezEdit On-screen keyboard in accordance with embodiments of the present disclosure;

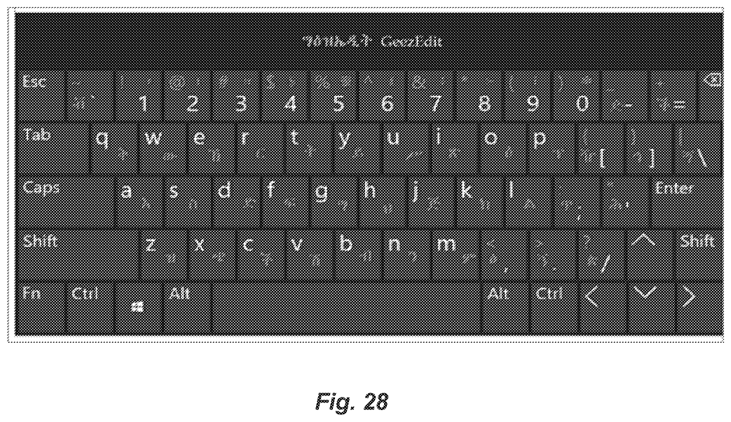

FIG. 29 shows a GeezEdit language group menu in accordance with embodiments of the present disclosure;

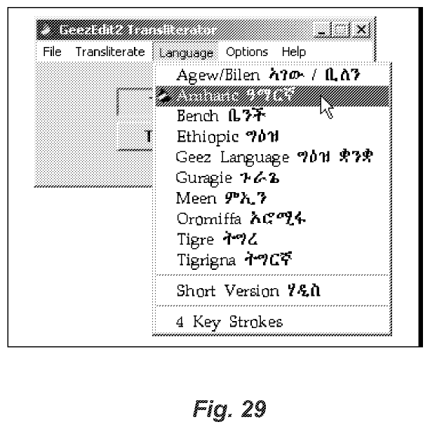

FIG. 30 shows an example keyboard in accordance with embodiments of the present disclosure;

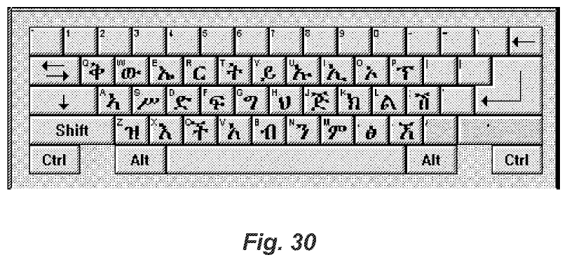

FIG. 31 shows Ethiopic plus in accordance with embodiments of the present disclosure;

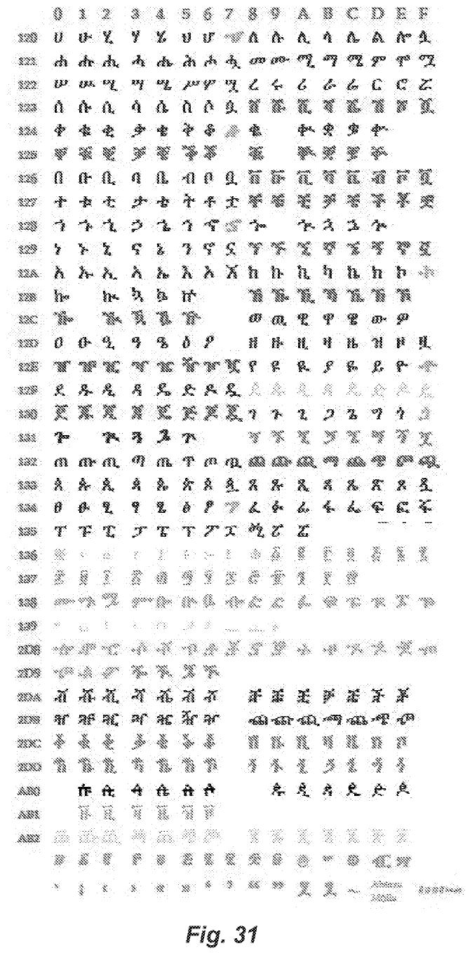

FIG. 32 shows Ethiopic keystrokes in accordance with embodiments of the present disclosure;

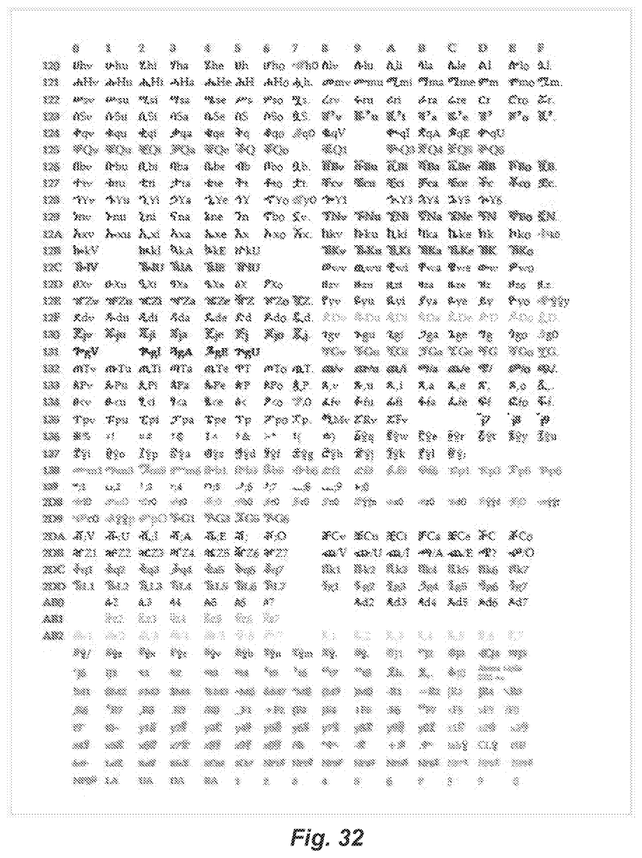

FIG. 33 shows a first portion of a typing table in accordance with embodiments of the present disclosure;

FIG. 34 shows a second portion of a typing table in accordance with embodiments of the present disclosure;

FIG. 35 shows a third portion of a typing table in accordance with embodiments of the present disclosure;

FIG. 36 shows a fourth portion of a typing table in accordance with embodiments of the present disclosure;

FIG. 37 shows a fifth portion of a typing table in accordance with embodiments of the present disclosure;

FIG. 38 shows a sixth portion of a typing table in accordance with embodiments of the present disclosure;

FIG. 39 shows another typing table in accordance with embodiments of the present disclosure;

FIG. 40 shows a first portion of a typing table for a virtual keyboard in accordance with embodiments of the present disclosure;

FIG. 41 shows a second portion of a typing table for the virtual keyboard in accordance with embodiments of the present disclosure;

FIG. 42 shows a third portion of a typing table for the virtual keyboard in accordance with embodiments of the present disclosure; and

FIG. 43 shows a fourth portion of a typing table for the virtual keyboard in accordance with embodiments of the present disclosure.

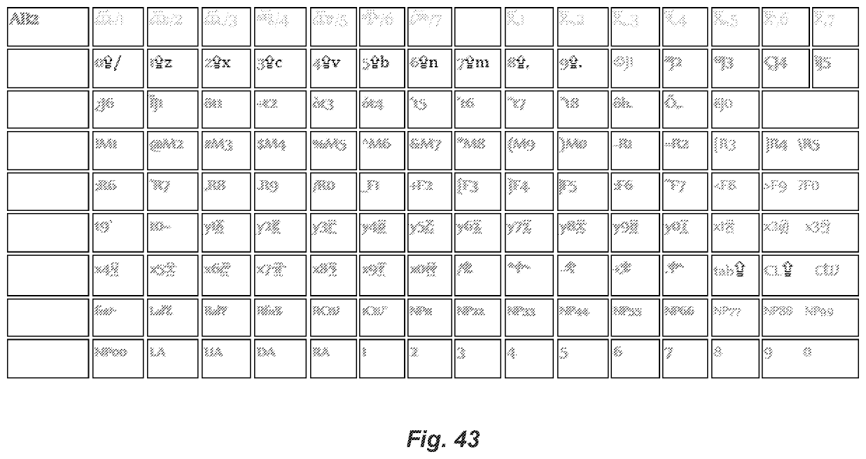

### DETAILED DESCRIPTION

Embodiments of the present disclosure will be described in connection with a method for typing characters or glyphs on a QWERTY keyboard.

The present disclosure addresses the issues associated with art related methods. It has already been shown that 14 glyphs can be rendered and settled from the “A” and “E” keys alone with one and two keystrokes. The combination on the computer keys was sufficient for Ethiopic with the same pattern. It is possible to decrease the key and thus the layout of computer keys while also increasing the width of smartphone keys to a limited extent.

The present disclosure offers inventive concepts directed to enabling a keyboard (e.g., a QWERTY keyboard) to be rendered and settled using a maximum of three keystrokes. Given the 25 command and other keys, 25×2×47 gives 2850 glyphs. The third key may be required because abbreviated computer and smartphone keyboards required more than two keystrokes to type numerous characters. In some cases, the layouts for computers and smartphones are almost the same as in the Latin layouts.

For a thorough understanding of the embodiments of the present disclosure, real examples will be described hereafter. It is to be understood that the below examples are in no way limiting, and additional or alternative implementations of the aspects of the present disclosure are possible.

More characters can be rendered than those discussed herein because, for example, keys such as “tab” are used as regular as well as shifted keys adding doubled features. For instance, “tab 1” and “depressed tab 1” (“ [symbol] 1”)—where the user holds down the “tab” key while pressing the number “1” on the keyboard, gives different glyphs doubling the use of the “tab” key. In some examples, “Tab 1” renders “ [symbol] ” or [symbol] or “!” “while “ [symbol] ” renders “1”. Similarly, “tab q” may generate different characters from each of “ [symbol] q”, “q tab” and “Q tab”.

The settlement of the default has been discussed and protected by other patents. An addition in settlement of the single Ethiopic glyphs by numerous secondary activities. The logic is because Ethiopic can't share the default with English and accomplish similar characteristics at the same time. One such example activity is the settlement of the solitary glyph by adding a non-printable glyph. This applies to glyphs generated with one glyph ( [symbol] ) or more as ( [symbol] ) glyphs. This also apply to those like the vowel ( [symbol] ) keys. This is because such glyphs could also be typed with one “a” or “aa” keystrokes. The need to shorten or narrow the keyboard has also been met. In other words, a keyboard with three rows of ten keys and the numbers can handle Ethiopic in computers and smartphones. A few extra keys smartphones require can be assigned to the bottom while the command keys can replace these in computers. The ten number keys can be kept, removed, or replaced with Ethiopic. It is recommended that it remain in the top row for convenience too.

In some embodiments, all the more than 500 or so Ethiopic glyphs may be typable using a QWERTY keyboard. When the keyboard is rendered (e.g., via a smartphone), it is possible to use a keyboard with 10 glyphs per row. In some cases, 11 keys per row may be preferred because there is enough space in landscape view to render all 11 virtual keys for the virtual keyboard. While the standard QWERTY keyboard includes the letters QWERTYUIOP in the top row, ASDFGHJKL in the middle row, and ZXCVBNM in the lower row, the Ethiopic keyboard has 10 per row. The current Ethiopic method also uses the semicolon, comma, period and slash keys for rendering Ethiopic characters. Unlike the lower row of the Latin keyboard, the lower row of the Ethiopic (e.g., Geez) keyboard can accommodate the command keys in computers or additional glyphs for smartphones. As before the Ethiopic has the numbers in the top row.

As previously noted, examples that specify particular glyphs associated with specific keys are in no way limiting, and a particular glyph may be assigned to different keys in different embodiments.

In some embodiments, each Ethiopic vowel may have its own designated key. For example, an additional “a” may be bound to the “x” key. The “ [symbol] tab” key now also has a function. The “v” key that was alien to Ethiopic even in the older keyboards has been moved to represent the lost first order as the shifted positions have been given to some first order glyphs. The involvement of the “v” as a vowel for first order is to add more vowels to Ethiopic. While the “ [symbol] ” character is typed with “xv”, it can also be typed with “vv” while “Vv” types “ [symbol] ”. Additionally, the period or “.” may provide an optional eighth and ninth vowel keys. This also goes with the principle that “ [symbol] ” is the eighth vowel form of the “ [symbol] ” order. This new introduction is also to give the eighth vowel an optional third option specially for virtual keyboards. As before more keys were brought to the default positions, though their functions have been modified. In some cases, glyphs that were displaced by the vowels and were given their own keys at the bottom may be moved to the number keys. The period key has also other uses such as a first key to type the Meen “ [symbol] ” series and an example is “.h” or “.D” for “ [symbol] ”. In this approach the period key also doubles as a ninth or “ [symbol] ” vowel key. The “period” when followed by a single or shifted glyph types the eighth vowel as in “1.” to type “ [symbol] ”. It can also type more symbols as second keys with the numbers, etc. It is also possible to use the shifted number keys for typing others rather than the Ethiopic symbols only as in typing Ethiopic period with “shift 3”.

In some embodiments, the Ethiopic alphabetic numbers may be typed with “ [symbol] ” and the “q” alphabetic row (e.g., the top row of the QWERTY keyboard). For example, “QWERTYUIOP” types “ [symbol] ”; these Ethiopic alphabetic numbers may be typed with the numeric keypad numbers followed by the keys on the number row provided the number are in default state.

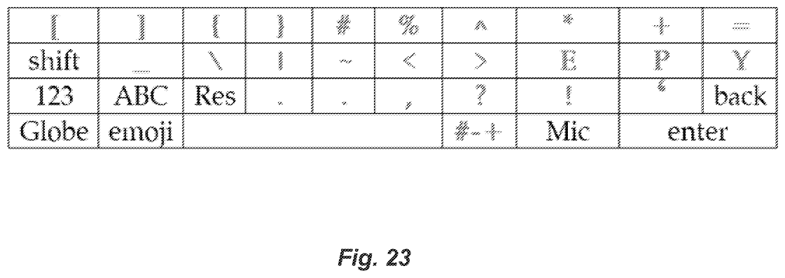

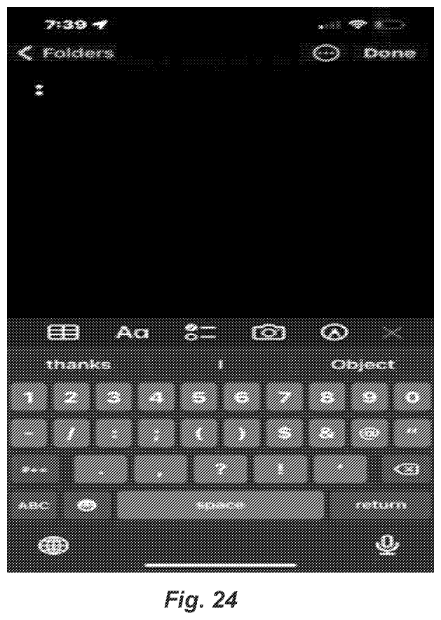

The Ethiopic numerals “1234567890” can be typed directly from the ten numeric pad numbers “1234567890”. A second method is typing them with “ [symbol] ” (shift tab) and the bottom row of the QWERTY keyboard (e.g., “zxcvbnm, ./”). Other methods are also available. The most effective way of typing these numbers is to assign them the positions of the Arabic numerals above the QWERTYUIOP row or to the numeric pad. There are also methods where “shift tab” and the number keys are simultaneously depressed and involve programing and these are to show the capabilities. This is different from the result for “shifted tab” followed by the number “1” where the “shifted tab” does not generate anything and the “1” key results in the “!” or any other glyph. This typing is also different from regular three-keystrokes as in typing of “ [symbol] ” with “Nu” and others. The alphabetic Ethiopic numerals “ [symbol] ” can be typed with the shift key (e.g., “ [symbol] ”) and “ASDFGHJKL:”. In the smartphone environment the three numeral types can be assigned to the “123” button. The “#-=” that is even introduced to the Latin smartphone is to accommodate the symbols as shown in FIGS. 23 and 24.

As mentioned above, embodiments of the present disclosure allow generation of numerous glyphs including bidirectional typing. In one embodiment, different Geez glyphs may be generated based on whether a key is held down while another key is pressed. For example, the user may press (but not hold down) the “tab” key followed by a second key press, which may generate a different glyph than when the user holds down the “tab” key while striking the second key. As an example, the glyph “ [symbol] ” may be generated from depressed “tab” followed by “q” (e.g., the user holds down the “tab” key while pressing the “q” key). A non-depressed “tab” followed by “q” (e.g., the user merely presses but does not hold down the “tab” key, and then presses the “q” key) generates “ [symbol] ”, a different glyph. It is possible to add more combinations but one has to be careful not to interfere with the typing. For instance, an example of a typing sequence not recommended because of potential confusion by the key sequences is typing of anything more than the “ [symbol] ” with “q”. “q” followed by the typing of “tab” could generate “ [symbol] ” or “.” or another glyph. Such combinations have been avoided to simplify the typing methods, but such combinations are still possible and intended to be covered by the present disclosure. One reason why “q” followed by “tab” is discouraged from typing a glyph other than “ [symbol] ” may be because such an action may take away the rendered glyph. The second reason may be because the “tab” key is also the first keystroke for other characters or glyphs, such as rendering “1” by typing “tab 1”. In this case, typing “q tab 1” may result in “ [symbol] 1” being output, which should not be interfered with by treating the “q tab” keystrokes as the user trying to type “ [symbol] ” or some other glyph.

In some embodiments, the activities such as double strike, long hold, timeout as well as settling popup lists with highlighted vowels or characters with or without the glyphs may be implemented. These follow the settlement at zero time and include nonprintable glyphs. The number “1” could be typed by long hold of “q”. Long hold of “a” to generate its accented varieties could be populated with the Ethiopic order forms. Since the purpose of typing is to put down the characters without seeing the screen, the idea of bringing up the “ [symbol] ” or the “ [symbol] ” and “ [symbol] ” as well as related glyphs to pick up one with a second keystroke, this approach may be beneficial for teaching the alphabet.

Ethiopic was computerized by distributing the Ethiopic orders on eight Latin fonts. When one selects “F1” key, that brings up an Arial font and clicking on the “a” key renders the “ [symbol] ” glyph with the second keystroke. When one switches to a Times Roman font with “F2” the second order font is recalled. Striking the “A” key brings up the “ [symbol] ” glyph that is typed and settled. This is repeated for a total of eight fonts for the eight Ethiopic orders. The typist saved the Ethiopic documents made up of characters from eight fonts. If the document were highlighted and the fonts are changed to a font it ends up with only one font and the Ethiopic document got messed up. One needs the presence of the eight fonts to read the documents.

With the typewrite version, one needs only one font made out of character pieces. The typewriter fonts are fragments assembled on an ASCII font and needs the font to read it. Nothing will happen if one highlights the font and changes the font provided the font is there on the computer. If the font is not there, the whole document would be changed to a gibberish English font.

In some embodiments, a QWERTY keyboard may be used. Unless otherwise specified, a “QWERTY keyboard” refers to a keyboard layout for Latin-script alphabets. The QWERTY keyboard includes the 26-letter ISO basic Latin alphabet. In some cases, the QWERTY keyboard may be or comprise an ASCII keyboard layout, or any other known layout. Similarly, in a virtual environment, the QWERTY may be or comprise any virtual keyboard rendered to a smartphone screen with which the user may interact. The layout varieties of the keyboard include function key types, the vowel varieties, the numeric and the symbol types. The new novel methods allow more than one typing method at the same time or more than one layout from the same keyboard. In the smartphone system (e.g., a QWERTY keyboard rendered to a smartphone screen), the keyboard may include 10 or 11 keys per row. However, an additional or alternative number of keys may be rendered per row.

It has been described in previous patents that Ethiopic documentation requires specifying the Ethiopic code and the typeface as in ModEth and EthioWord or the Unicode codes as in GeezEdit for computers and smartphones. The Ethiopic Unicode glyph codes were typed and settled either after a timeout or at the time of typing. Additional features such as including non-printable codes to block changes are new additions. Though what is important is documenting the Unicode and the specified typeface, any available code can be utilized when the typeface is not available. The applications allow incorporation of the Ethiopic typeface name and import/export of the key sequence tables controlling the typing methods across apps.

Embodiments of the present disclosure provide compatibility between operating systems and applications. The present disclosure is described with developed apps such as GeezEdit, which is memory resident and works the same way with the exceptions for abbreviation in smaller gadgets such as smartphones. The present disclosure also works in numerous apps such a Microsoft Word, Notepad, Google, iPhone and even EthioSuite. The same layout is utilized in apps such as EthioSuite for computers. EthioSuite is a dedicated publisher developed over the last decades with the Ethiopic needs in mind. It has numerous features to build dictionaries, spell checkers, etc. for Ethiopian and African languages. The embodiments of the present disclosure allow Amharic as a default language character set and a menu system to switch to the dozen other sets. Ethiopic is to use all the more than 500 Geez glyphs at the same time from the same keyboard as before. If there is a conflict, the second language would be given an alternative typing sequence. Programing includes the typeface.

The Ethiopic typeface is the same old TrueType from 1989 that lost some of its glyphs because of migration to Unicode. The GeezEdit Unicode typeface is supplemented with GeezEdit2 that has some twenty Ethiopic glyphs created but not yet included in Unicode. The apps allow switching of the typefaces in the background. The typefaces include their own Latin alphabets. The programming includes incorporation or removal of the English part of the encoding.

Turning to the logic of the layouts and typing methods, each character in the set of characters may be typed using a maximum of three keystrokes, as discussed in further detail below.

Some glyphs or characters may be formed using a single keystroke. For example, the “ [symbol] ” or “ [symbol] ” glyphs can be typed with “12345”, “67890”, “890-=”, “vuiao”, or “VUIAO”, respectively. In other words, the glyph “ [symbol] ” can be typed using the “1” key, the “6” key, the “8” key, the “v” key, or the “V” key; the glyph “ [symbol] ” can be typed using the “2” key, the “7” key, the “u” key, or the “U” key; etc. These single keystroke glyphs may also be typed with “/*−+” from the numeric keypad. One can also type these in a reverse way by first striking the vowels instead of the consonants. The eight vowels of the Amharic layout may be typed with a keystroke each, and as such may be treated as default keys.

Some glyphs or characters may be formed using two keystrokes. For example, glyphs or characters may be typed with vowels, number, and command keys on a QWERTY keyboard. In one example, the Hele layout also has the three varieties except that the second is in the third row starting with “X”. Single keystrokes could also have the non-printable codes added if there is a need not to change the single keystrokes.

Some glyphs or characters may be formed using three keystrokes. In general, there are 5 options to use any key on the keyboard. For example, the “q” key may be used with another vowel key (which may be bound to the “v” key) or with another number key (e.g., the “1” key, and may be capitalized or not, yielding, for example, “qv”, “qV”, “q1”, “Qv”, and “Q1” as possible combinations. If one chooses a keyboard with three rows of 10 keys each, a total of 300 glyphs can be typed. In some embodiments, the command keys and the keys associated with the numeric keypad can also be involved to increase the possible combinations for rendering glyphs or characters. For example, the “4” key can type “ [symbol] ” by default and the orders typed from here with “vuiaeo.” This can also be performed from the “X” key with the same vowels while the vowel keys alone also type them. “ [symbol] ” is typed from “A” or “XA” keys or as “a” and “xa”. “ [symbol] ” could also be typed with “XA” rendering only one. As a third choice of the letter forms of the “ [symbol] ” orders can also be typed from the “vauiaeo.” keys and there is no need to use the “X” key” other than making things simple. In this configuration “vv” renders the “ [symbol] ” and the rest as usual from the “uiaeo.”. The “ [symbol] ” orders are typed from the shifted vowel positions. “ [symbol] ” could be typed from the “8” or “.” key. Typing of the “ [symbol] ” with is novel. The “4” key can also type “ [symbol] ” in another configuration.

“Tab 1” could also type a tabbed 1 by long hold of the “tab” key. In the current disclosure the default assignment was moved from “tilde” to the “!” key for the Ethiopic “ [symbol] ”. “Tab 1” still types “ [symbol] ”, but “Tab 1” could also be programmed for another glyph. “Shift tab 1” types “1”. Opening up the number keys as well as its rows may enable the user to use the number keys as a third vowel. The shifted numbers have retained their assignment to the Ethiopic symbols and “shift 1” types the Ethiopic space mark as shown in Table 1. Here key “8” has retained its vowel 8 function optionally and “18” types “ [symbol] ”. As mentioned above it is possible to type “ [symbol] ” with “q1” while “1q” typing has been left alone to type the default “ [symbol] ”. Long hold of the numbers or the glyphs in the “Q” row as well as introduction of the timeout adds more options. The number rows also render numerous other glyphs with others.

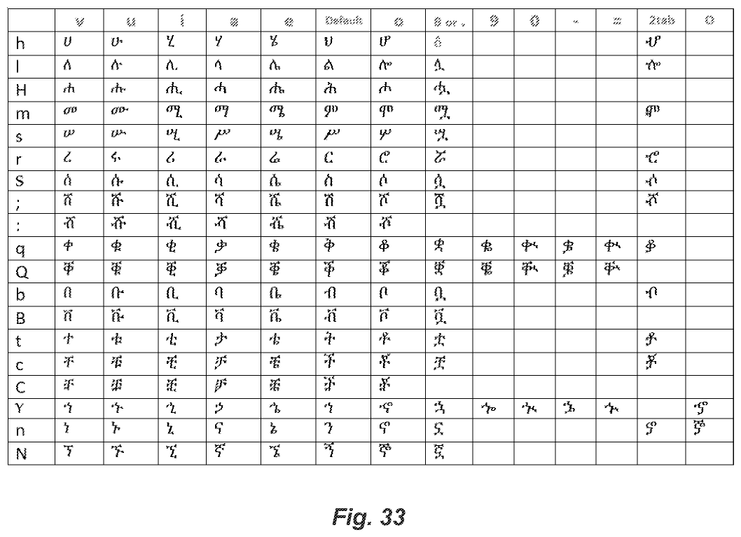

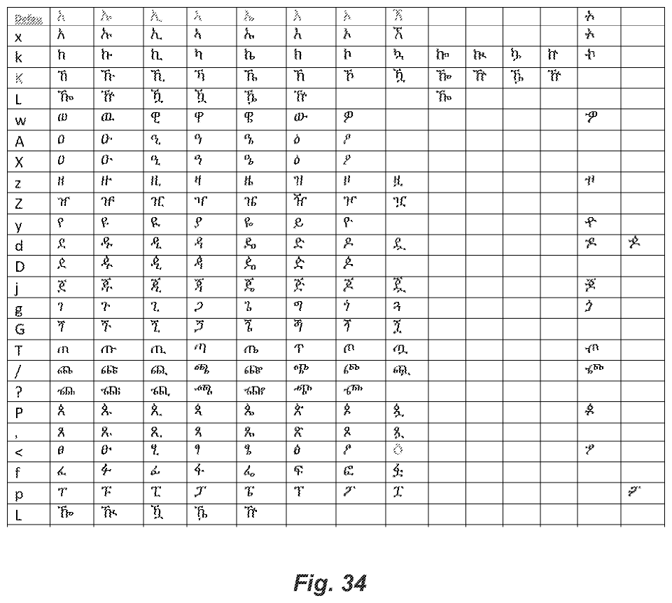

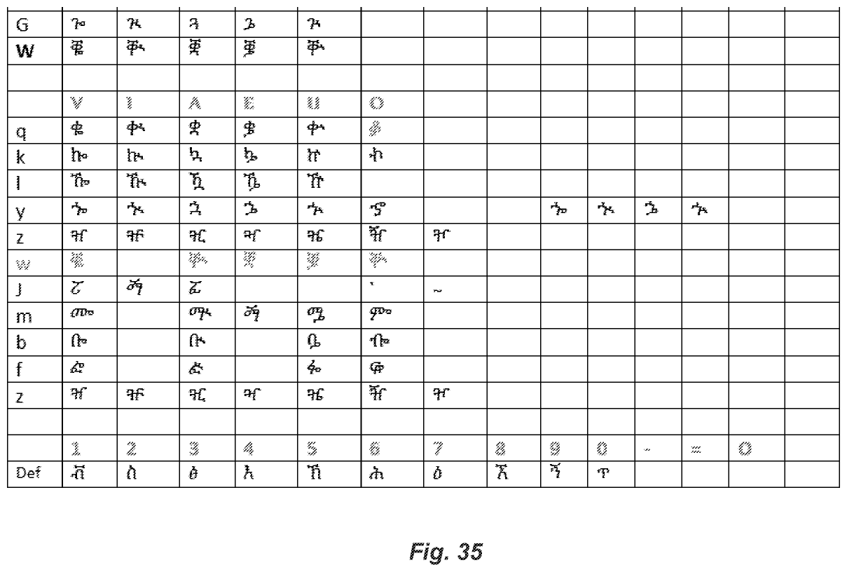

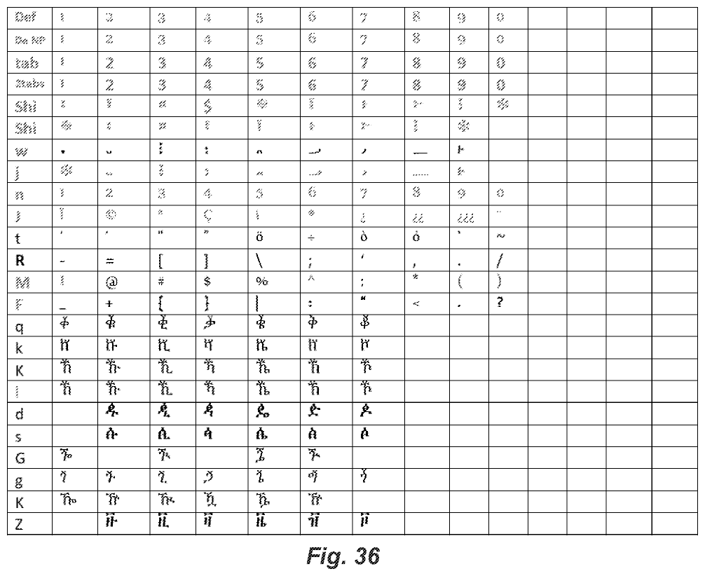

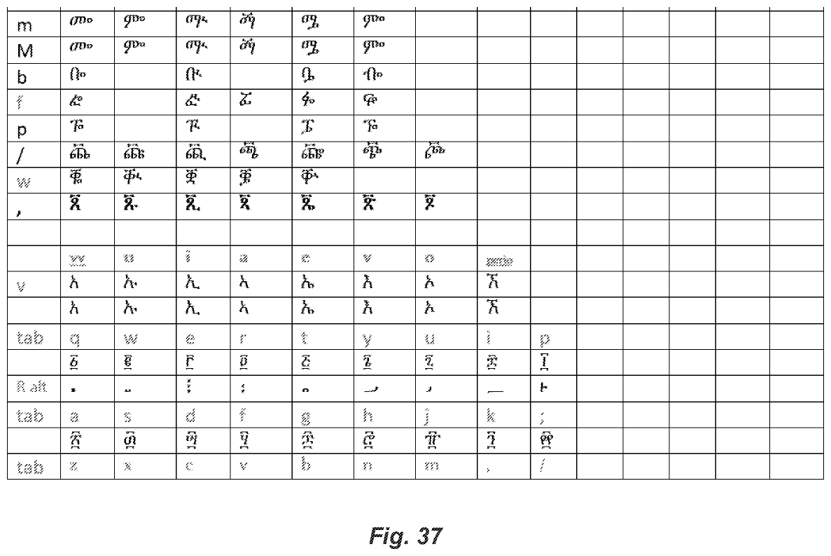

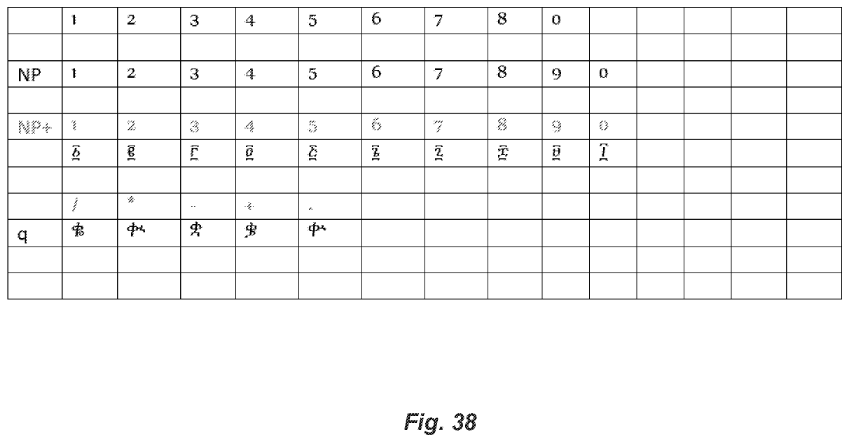

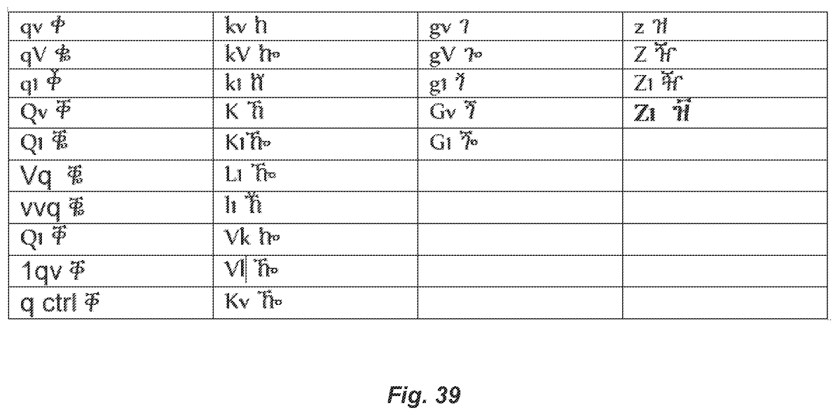

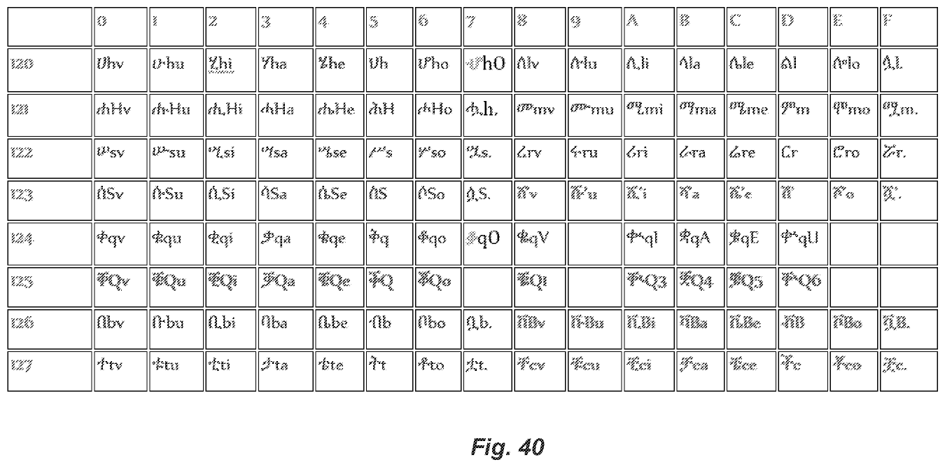

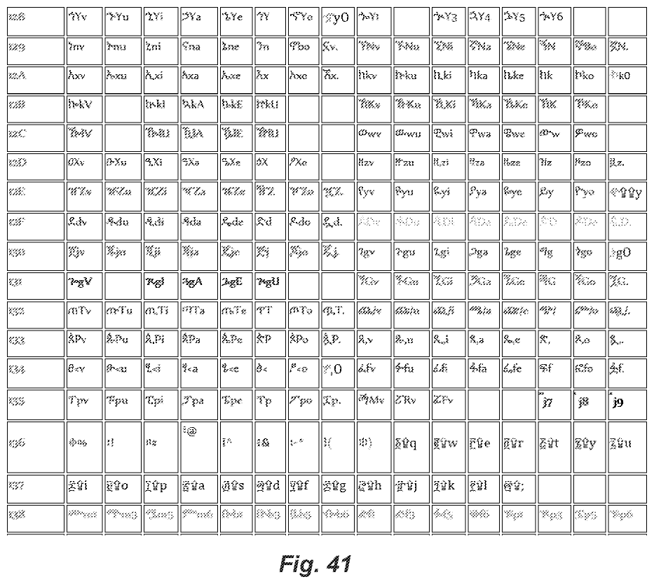

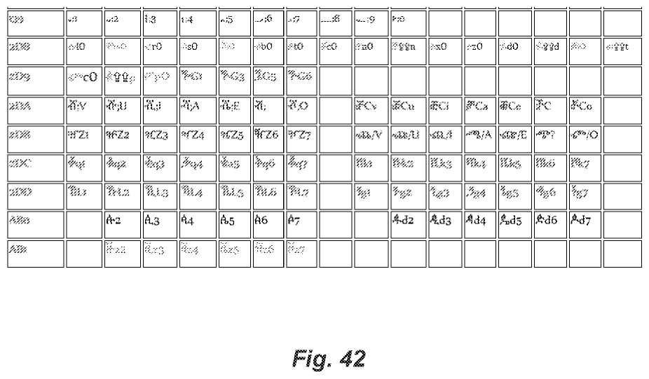

Three keystrokes can also be described in terms of their relationships with one and two keystrokes. For instance, every key can be utilized to generate third tier glyphs such as the “ [symbol] ” series from the “comma” key. Symbols such as “-= [ ] \;', ./” can be typed from the “>”. Reverse typing where the “>” is typed first with the ten keys could generate their shifted version or “-+ { } |:”< >?” glyphs though this is not necessary. “/” types “ [symbol] ” and “/6” types “ [symbol] ” while and “?6” types “ [symbol] ” and this is an example of typing the three sixth orders with one, two and three keystrokes. “J” or “j6” can type “ [symbol] ” and other free keys such as “W”, “.”, R, Y, F, P, M, N can type the groups “ [symbol] ”, “ [symbol] ”, “ [symbol] ”, “0123456789”, the stress and stretch marks and glyphs such as “ [symbol] ” and as shown in FIGS. 33-42, for example. “ [symbol] ” can also be typed with “MRF” respectively. The Ethiopic Meen glyphs series can be typed with “>” as in “1>” for “ [symbol] ”. These are just examples as the combinations are many. For instance, “ [symbol] ” can also be typed with “lO” or “.lo” and the system includes disabling of the Latin typing of these alphabets as part of the claim. A better method is to type the ones on the default key with “tab tab” as in “tab tab d” for “ [symbol] ” and “dO” for “ [symbol] ”. The [symbol] could also be rendered with “.q, vq, .h, .k, vk, .g, vg, .m, .b, .f, .p”. Better options are also available.

The “slash” keys on the keyboard and the numeric keypad are differently programmed. The number keys have been assigned to other characters and the “4” key can type “ [symbol] ” by default and the orders typed from here with “vuiaeo.” To make things simple a better alternative is to type the ten Ethiopic numbers from the number keys. This is also to familiarize it use.

“>z” can type “ [symbol] ” while “vvg” types “ [symbol] ”. “M” or “mO” can type [symbol] . There are 5 options to use a key; i.e. qv, qV, q1, Qv and Q1 without involving the command keys and thus there is no need for four keystrokes.

In the virtual keyboard an empty key was programmed to represent a character as previously described and included here. The best option to type [symbol] is with “lO” or “tab tab 1”. It is possible to type the “ [symbol] ” series from the vowels themselves and the “4” key. It is thus not necessary to use the “X” key for them. It is good to keep the “X” with “ [symbol] ” because this row of ten keys has some other uses too.

“ [symbol] ” is typed with “g.” while “ [symbol] ” is typed with “.g”. However, it is better to type “ [symbol] ” with “gO” or “tab tab g”.

With computerization of Ethiopic back in the 80's the “A” key was assigned to the “ [symbol] ” series while the rest of the vowels were also treated just as in the Latin system. The “a” key worked just as an “a” key as an alphabet and also as an “a” vowel. This feature was also shared by the other vowel keys. It was not necessary that there should even be separate “ [symbol] ” dedicated keys. Over the years the “tab” key was introduced as a third shift key and has now gained additional novel functions. The “a” key introduced next to the “a” key could have been used alone or assigned to the “V” key, though there was a suggestion that the “X” key be assigned to the “a” series a while back. The current disclosure shows that the “a” on “X” is not necessary as the “V” could cover it. It should be remembered that striking the “Q” key is different from typing the “q” letter. Similarly, the “ [symbol] ” is the Ethiopic name while “ [symbol] ” is what it types by default. The key names are typed with shifts in Amharic and English layouts.

With abbreviation of the keyboard there is a need for an eighth vowel and the “period” key was introduced as a novelty. Thus, an optional typing of the Amharic eight vowels are “ [symbol] ” typed from the “X” key followed by the “u, i, a, e, o and .” keys. The “ [symbol] ” Meen series or ninth vowels can be typed differently, preferably with the “tab” key though the “period” cab be utilized for it too.

It should be understood that what has been described here are examples and not limiting and may not even have to work at the same time as the combinations are larger.

Another option especially for the virtual environment as in smartphones, custom screen virtual keyboards for computers as well as on-screen keyboards is to eliminate the number row. This is because there are enough spaces under some keys that can accommodate glyphs other than default and shift. A better option is to double strike the default key to get to the third keyboard layer instead of going for the numbers. “qvq” or “qvv” can type “ [symbol] ”.

The most difficult ones are the Guragie extensions where they share the keys with other related series. Even here only forward typing was used eliminating reverse typing. Here, for instance, “gv”, “gV”, “Gv”, “g1” and “G1” could type “ [symbol] ”, “ [symbol] ”, “ [symbol] ”, “ [symbol] ” and “ [symbol] ” respectively. On the other hand, the “ [symbol] ” and “ [symbol] ” series have three each forcing partial sharing of the “ [symbol] ” elsewhere as on the “L” or another key. Another modification would have been to combine the “J” and “L” on a key and dedicate one of these keys to the “ [symbol] ”. Other modifications such as combining the “R” and “T” keys is possible specially to create more vowels.

It is possible to use the “v” key for the “ [symbol] ” instead of the “X” or “4”. “vv” could type “ [symbol] ” considering “v” as the default for “ [symbol] ”. Since “v” is also the second stroke for the default sixth order Ethiopic glyphs, the pattern can't be followed and this is not worth it because of the potential for confusion. More important than that use of “v” after a default keystroke for any glyph overrides the “vv” from representing the “ [symbol] ” or typing the “ [symbol] ” with “vvv”. “period v” can type “ [symbol] ” considering the novel use of the key as “period” in three new ways. One is its function as eighth vowel for the “a” or “ [symbol] ” series as in typing of “ [symbol] ” with “v.”. The second is its unconventional use as a second keystroke to type “ [symbol] ” or “ [symbol] ” with “period v”. The third is the use of the period key as a ninth vowel for the Meen glyphs typed as second keystroke with “tab tab” and “period” to type “ [symbol] ”. “vv” types “ [symbol] ”. “ [symbol] ” can be typed with “v tab”, “e tab” etc. Also “depressed shift v” still types the Ethiopic four numeral or “4”.

“uiaeo.” may type “ [symbol] ”. It should be remembered that the coding for “depressed shift tab v” means the shift key is depressed while typing the “v”. This is different from “tab v” coding that could render nothing as a dead key, or render one or two glyphs. These are new claims. As shown above, it is possible to type the “ [symbol] ” series in four ways. In fact, the vowel keys can be utilized in more ways and includes the typing of “caps lock”. While these options for typing the “A” series are available, it is still better to assign the key to “X” for a few reasons.

Stress and stretch marks, tones and other essentials have been added specially for use in African languages. New glyphs can be created and three keystrokes such as “.q1” to type “ [symbol] ” can be incorporated. The Ethiopic glyph for stretch mark is “˜” introduced herein. “tab/” could types “ [symbol] ” or “caps lock” that is to describe depressed shift as in the case of the “tab” as opposed to regular “shift” usage.

In some Ethiopic apps the glyphs in the shifted positions of the numbers are disabled to use them for English spelling of Ethiopic, though it is not spelling either. Ethiopian Computers & Software have used all the English symbols of the keyboard as part of the Ethiopic system. “r”, “1”, “W”, “X”, etc. can now be used to type some English symbols without switching to that font. An option in EthioSuite is to strike the F4 function key to switch in and out of the Ethiopic to English in EthioSuite.

Ethiopic can fit on the smartphone layout for English at the expense of some convenience. “tab” and other command keys can be moved down to the fourth row. In another configuration the “R” and “Y” keys can be combined while the “Y” can be the vowel for the first order Ethiopic. This can also be done for “F”, “J” and “L” keys at the expense of starting all over. It may even be better to give glyphs such as “ [symbol] ” its own key instead of combining it with “ [symbol] ” that is crowded with the “ [symbol] ” and “ [symbol] ” alphabets.

It should be understood that all the Ethiopic characters have to be accommodated with no more than three keystroke typing and fit the abbreviated computer and smartphone keyboards. An Amharic keyboard that can't accommodate other Ethiopic sets is unacceptable. It is not necessary that Amharic has all the Ethiopic, but should work independently allowing expansion to all Ethiopic.

It is possible to come up with a dedicated Amharic set by typing “1” with “tab q” and “ [symbol] ” with “shift q”. This needs only the “tab” button and the “#=+” button added.

The period key is also as ninth vowel for the “ [symbol] ” series. “ [symbol] ” can be typed with “period tab” and this is a new claim. However, this interferes with the use of the period key as eighth vowel and this feature is changed to “tab tab period”.

It should be remembered that the positions of the alphabets as well as the glyphs are examples and not limiting. For instance, the alphabets on the default number keys are optional and not necessarily needed there as they are there elsewhere. Probably a better choice is to assign the working Ethiopic numerals to the number keys. This will encourage Ethiopians to use the novel Ethiopic numerals while the world gets ten new numeral symbols, “0123456789”. These numerals can be typed from the numeric keypad, with “tab” followed by “zxcvbnm,./”. They are also the default numerals of the numeric keypad.

Numeric keyboard one or “1” followed by Arabic “1” renders the Ethiopic alphabetic “ [symbol] ” while switching the font and this is another claim because the app involves specification of more than one typeface at the same time while documenting them.

EthioSuite is an Ethiopic publisher more sophisticated than ModEth and the Ethiopic features that are alien to Latin are claimed. GeezEdit is to share other app with Ethiopic. It has its own Text Control.

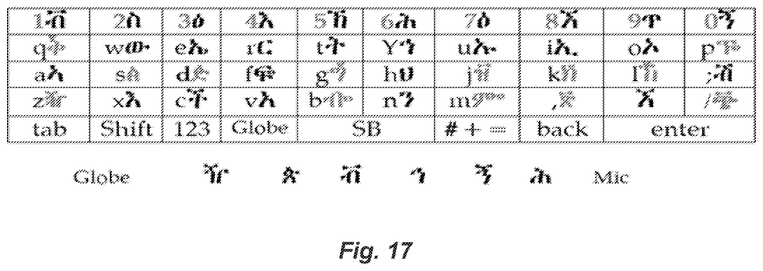

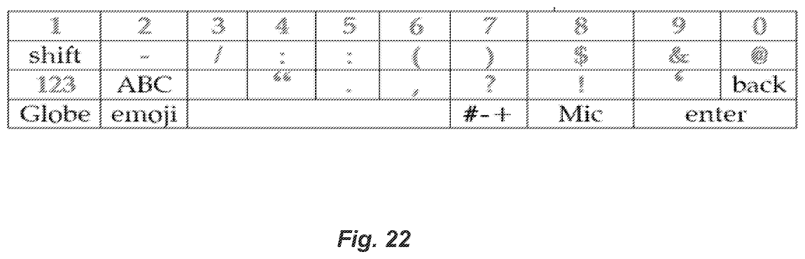

Description for the Hele layout as well as the smartphone versions of what was discussed above for the QWERTY are modifications. The modifications for smartphones need layouts to accommodate abbreviations. The system has the same thirty default keys out of which the eight are vowels. As shown in FIG. 17 there is a need for four rows for the defaults while the fifth is for commands. The “shift” key brings up the second layout FIG. 22. The “123” brings up the number pages. The “#-+” brings up the third tier glyphs to be typed with the vowels there.

The third vowels can be typed with double striking the sixth orders. Example: [symbol] with y, [symbol] with Y, [symbol] with ym, [symbol] with Ym and [symbol] with y6.

The reason why the numeric keypad doubles the Ethiopic numerals is because smartphones and the like do not have a numeric pad. “v” is a dead key to make typing simple.

Some of the Ethiopic characters at the bottom row shown in previous patents can also be replaced with other glyphs or vowels specially in virtual keyboards. It should be understood that abbreviation of the Ethiopic keyboard from the previous one spread over the 47 to the 36 or 26 current keys do not mean abandonment. For instance, the “[” keys can be used to type “ [symbol] ” where available. This is because the previous assignment can still be accommodated where necessary. Even the key names have not been changed, but modified to accommodate the changes. The name of the “Z” key is still the “Ethiopic “ [symbol] ” while it renders the “ [symbol] ” on striking it just like the English system as before. Some modification includes giving “z” to “ [symbol] ” and “Z” to “ [symbol] ”. However, the “ [symbol] ” key renders “ [symbol] ” because it is the most commonly used order and this is also similar to typing “z” from the “Z” key.

The tables show the typing sequence examples and are neither exhaustive nor utilized at the same time, though they are part of the claim. whatever is to be standardized on consensus would then follow other features such as physical key labels. Priority would be given to what Ethiopic needs and an example is where the default keys on smartphones could be Ethiopic ones in excess of 26 instead of necessarily the English 26.

The smartphone keyboards are compatible with the computer keyboards with minimal differences. It also eliminates the need to depend on scooting through vowels while even adding more vowels or glyph keys above or below the last row and this is a new claim.

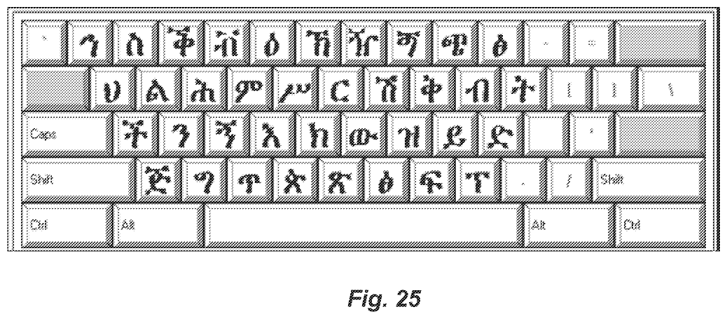

In the past the vowel keys were used as letters and vowels. Introduction of the current methods where they become dedicated, more keystrokes and abbreviated keyboards were required because the vowels were dedicated vowels. To make up for the inefficiency, it has become necessary to increase the keystrokes to three also because of the need to limit the typing around the “F” and “J” home keys. The current disclosure is another first to type the complete Ethiopic in a virtual environment. A default of thirty keys along with a row of ten numerals is sufficient. If one is to imitate the Latin keyboard, a few more glyph or vowels can be added at the bottom as in FIG. 25. Of the thirty keys seven, “vuiaeo” and “period”) have been assigned to the seven orders (“ [symbol] ”) and the sixth (“ [symbol] ”) is default. The “tab” key has also been introduced for the ninth (“ [symbol] ”) order. This eliminates the need to depend on scooting method for typing. This does not mean that the current novel method does not include scooting, the appearance of the glyphs on the vowel keys, balloons and pop-ups as well highlighting them glyphs. It is also possible to render the “ [symbol] ” series from “4”, “8”, “left ctrl” and “right ctrl” keys.

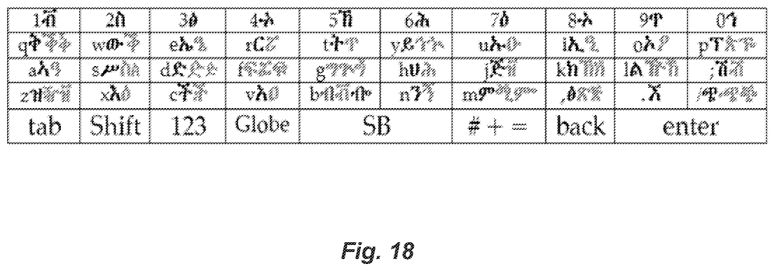

The Startup is followed by the appearance of the default keys along with the “Globe”, Shift”, “tab”, “123” and “#-=” keys, as shown in FIG. 18. The defaults that include the “ [symbol] ” are changed to their vowel forms with the seven vowels “vuiaeo.”. The number keys here as well as the Shifted “ [symbol] ” vowel keys “VUIAEO.” type more glyphs. The Shift key brings up the glyphs in the shifted positions, to be modified by the vowels depending on the need while presenting the shifted dedicated vowels (“ [symbol] ”). The “tab” brings up the number keyboard to type each with a keystroke. The “123” button recall the symbols to be typed with one keystroke each. The “#−=” bring up third tier glyphs to be modified by the vowels depending on need. The novel “#−=” is also introduced to the English keyboard to replace the “#=+” key to avoid an extra keystroke. A row of ten keys can be utilized though eleven has not been ignored.

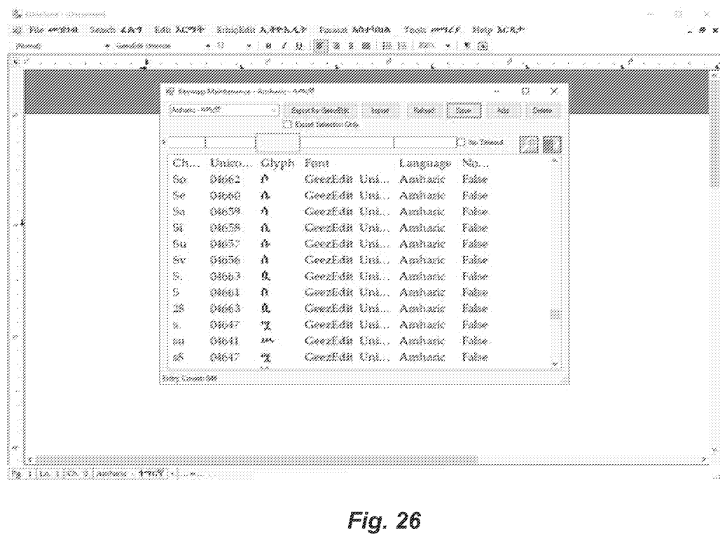

The key sequences have been shown in the tables and the FIG. 26 with minor differences between the computer and the smartphone versions. In general, the command keys of the computer and those of the smartphones could occupy the bottom row. Modifications for the Hele keyboards are close to those of a smartphone (as shown in FIG. 25). The Hele ( [symbol] ) layout includes a novel vowel assignment to the ten keys in the “z” row. In general, Ethiopic requires more vowel keys than conventional methods and the invention meets these requirements with numerous claims to list them all. The innovation is also helpful for other Unicode glyphs and opens up the regular English for other layouts too. Teaching materials for English typing can also be used for Ethiopic and a row with ten keys is satisfactory especially with the excellent phonetic nature of the Geez alphabet.

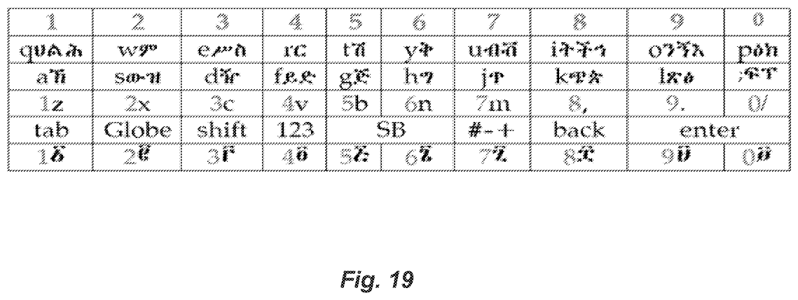

“#−+” and k should present the “a” to select the “ [symbol] ” vowel form with third keystroke, as shown in FIG. 19.

The new “#−+” key to avoid “123 shift”. Striking the “#−+” key on the default keyboard presents the shifted symbols. From there the user can go to the “123” or “ABC” page. The user can also type more than one glyph from this keyboard. The important point here is because this eliminates going through two keystrokes to get to the shifted symbols. This is because the user already knows default symbols present on the “123” keyboard. Thus, all one needs is to strike the “#−+” key to get to the symbols such as “[”, “]”, “{”, etc.” on the shifted positions.

These inventions were improvements over the memory resident apps for computers and smartphones as well as the independent EthioSuite. The apps could use any typeface or modified for even non-Unicode glyphs. The layouts as well as the typing methods can be modified as necessary. The menu structures can be modified for use in different solitary Ethiopic-user language groups as well as the whole Ethiopic with over 500 glyphs.

The extra current novelty has the following features:

In the current invention the “tab” key kept its previous features and new ones were introduced such that striking a “tab” key as second keystroke to generate glyphs was eliminated. This is not because of any problem other than consideration of the compatibilities of the typing methods between the assignments. To show this problem by examples if striking, say the number “1” key is to generate “ [symbol] ”, it is important that both “tab 1 and “1 tab” generate a glyph from the two keystrokes and the steps completed. This is because the “tab” key has some other functions and the steps have to be terminated after the keystrokes. “1 tab q” generates “ [symbol] ” because the default assignment of “q” is “ [symbol] ”. “tab 1” also generates “ [symbol] ” for the sake of avoiding confusion to the typist while “tab q” generate only “ [symbol] ”. It is also possible to generate a different glyph from “q tab” though that is not recommended because it interferes with “ [symbol] ” typing by “q”. It is thus important that the “tab” be used only as first key only. This theoretically gives a total of eighty Ethiopic glyphs to be typed with the default and their shifted positions.

The “tab” key also has novel features in that a depressed tab (“ [symbol] tab”) key generates a different glyph as opposed to the non-depressed ones (“tab”) used just by striking it. This is one of the important new features of the invention. The depressed “tab” key generates “1” when it is followed by the “1” key. It is because “1” can be typed this way that the default “1” key can be assigned to “ [symbol] ” or “1”. Examples are where depressed “tab” keys followed by “q” generate “ [symbol] ”. The Ethiopic alphabetic Unicode numbers “ [symbol] ” are typed with depressed “tab” key followed by the “QWERTYUIOP” keys. Other examples are the glyphs generated this way with the “A” and “Z” rows.

Double tapping of the “tab” key is another novel feature different from the above two. This is because of the second keystroke of the “tab”. This theoretically gives another thirty glyphs to type. One possible use of this keyboarding is to utilize it as a ninth vowel documentation method. An example is where “tab tab d” types “ [symbol] ”. Unfortunately, this is good only for the default keys and others such as “ [symbol] ” have to be typed differently as in “dO”. It should be understood that the system was built to type with a maximum of three keystrokes and more are not excluded from the claims.

The striking of “q1” generate “ [symbol] ” or another key as before. This feature is now discouraged as it does not depend on timeout and that typing has been assigned to “ [symbol] ”, as an example, for the sake of maintaining compatibility among all Ethiopic glyphs. Because the “ [symbol] ” series are Guragie and not Amharic, that typing sequence is left for that language and not utilized by others such as Amharic. Amharic would use the default or the programmed sequences rather than disabling the sequence as an option. In Amharic and Geez language “q1” would type “ [symbol] ” and “ [symbol] ” in Guragie and Ethiopic. If necessary, the “ [symbol] ” can be typed with “ctrl q 1”.

The current system has novelty in that the number of keystrokes per glyph has been increased to three and this is a new claim. The typing of Ethiopic glyphs with one and two keystrokes and settling them is a new claim within the novel system. An example is “shift/” to render “ [symbol] ”. “/” should not type “ [symbol] ” because of interference with the “period” key and the pattern is not confirming. Also “?.” could have typed the eighth form of “ [symbol] ” if it were there. “>/” could have typed “ [symbol] ” though “/6” is a better option. The “>” typing is such that the shift is held down while the period is depressed and both keys are released followed by the “/” to type the “ [symbol] ” and this is another novelty.

The “period” key was also added as a new eighth vowel in the novel system. This is because utilizing the shifted keys allowed the availability of more than sixty keys. The period key just like the other seven “ [symbol] ” glyphs is typed with a keystroke to generate the eighth form “ [symbol] ” by default. “Period” types “ [symbol] ” as well as “x.” or “4.” and even “v.”.

Another novelty is the programmed use of the command keys, arrows and the glyphs on the numeric pad to type thousands of Ethiopic glyphs. One example is to type the 10 symbols on the number keys with period as second keys. Examples: 1234567890 for “−=[ ]\;',./” respectively on varieties of keyboards. Similarly, “period b” can type “ [symbol] ” though this is not recommended because of interference with “ [symbol] ” typing. An option to avoid this problem is not to make the “period” key dedicated to type the “ [symbol] ” vowel. Another claim is to make the “period” key dead and type “ [symbol] ” with “b period” (eighth order) and “ [symbol] ” (ninth order) with “period b”. Assignment of the “period” key to “ [symbol] ” is preferred since the ninth order can be typed differently.

A glyph created with one or two keystrokes is settled by including a second settling non-printable glyph such as 11743. This is an example of other claimed processes or activities not used before.

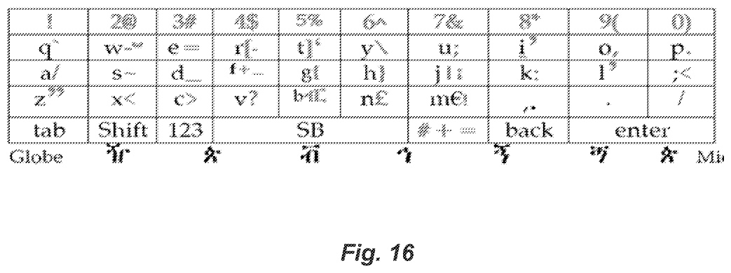

Unlike the computer keyboard it might be better to open up different virtual keyboards through the “shift”, “tab”, “123” “sym” and “#−+” keys. The shift presents the shifted glyphs such as “ [symbol] ” under “shift a” (as shown in FIG. 18). The “tab” recalls the forty numerals (FIG. 16), the “123” brings up the English symbol (as shown in FIG. 22), the “sym” is for the forty Ethiopic symbols and the “#=+” is for the third tier glyphs such as [symbol] (as shown in FIG. 17).

Some embodiments may implement additional features such as balloons, long hold, highlight or show the glyphs on the vowels or elsewhere.

Dedicated EthioSuite Ethiopic publisher with features such as dictionary, spell checker, building word list in different Ethiopic languages, indexing etc.

A method whereby the GeezEdit for windows works in Amharic at Geezedit.com while it also works in EthioSuite.

The use of typing a glyph in more than one method as well different layouts are introduced. More than one method of typing to type and render a glyph. Example. “ [symbol] ” can be typed with “h1” or “Yv”.

A method of typing each key assigned as a vowel with a keystroke each.

The novel invention includes methods whereby a default and shifted glyphs uses “vuiaeo.” for vowels, the third tier glyphs use 123456, etc., or 890−=. Extension glyphs such as “ [symbol] ” are typed with “q1” or numeric pad “q/”. “ [symbol] ” can be typed with “q3” or numeric pad “q-”.

Reverse typing is possible though that is avoided to make typing simple. Example: “aT” types “ [symbol] ” and “aaq” types “ [symbol] ”.

Extended ASCII characters can be associated to present Ethiopic in virtual keyboards. In computer keyboards second “/*−+ and .” can add more access. By agreement and based on logic, this can be modified.

There are numerous other methods. For instance, the second slash along with the numbers can type the “ [symbol] ” series. “Od” can type “ [symbol] ” provided that typing does not interfere with any other typing and follows the pattern.

Typing an “a” key once or twice still produces an “ [symbol] ”.

It is possible to assign the number keys to the “ [symbol] ” and “ [symbol] ” series and such assignments are avoided due to interference and should not be considered as novel as other options could alternatively replace them.

virtual with 10 or 11 in a row is compatible with the computer keys.

Rows and columns can be changed.

The command keys can be used as first, second or third keys to generate more glyphs.

Programing includes incorporation or removal of the English part of the encoding. It allows typing English from the same keyboard.

R9 types the “period” and the combination are many and minor modifications should not be considered novel.

In general, the current invention shows the numerous ways of typing a glyph and there is no need to use multiple keystrokes. For instance, the second slash along with the numbers can type the “ [symbol] ” series.

Apps such as GeezEdit for iPhone and android can access the computer versions while EthioSuite allows typing of the pervious patented methods. All one has to do is strike “F4” to deactivate the English. By default, the EthioSuite works with the methods described in this patent application. On-screen keyboard works with the keyboards as well as the mouse, though the later sequences are complete for all Ethiopic yet.

00032,04813,04772 is the code for typing [symbol] from [symbol] and it is not recommended.

Currently, the “−+=” keyboard where some Latin symbols are presented in smartphones is accessed after toggling though the “123” keyboard. Symbols such as “[”, “#” and “$” require three keystrokes to type and then get to the default keyboard. With the availability of the fourth keyboard, one extra keystroke is avoided. This is actually billions of keystrokes.

The method could utilize methods described earlier such as long hold, timeout as well as settling popup lists at zero time with or without the glyphs highlighting.

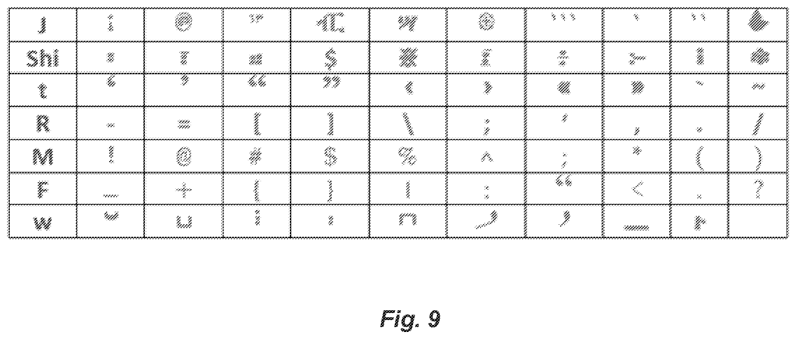

“1” with the “Q” row types 10 symbols if necessary and moving the characters around and adding mere keystrokes should not be considered novel. This is because additional typing sequences are available and only the major varieties are tabulated, (as shown in FIG. 9). Thus, the tables are part of the claims, but not exhaustive or to be utilized at the same time. Examples of not shown are “ctrl q” for “ [symbol] ” and other combinations with command keys.

A programming method of typing Ethiopic on computers, notepads, smartphones and related gadgets such that some Ethiopic glyphs are typed with a keystroke each and settled at zero time; Adding a secondary process other than settlement at zero time in the current method is possible.

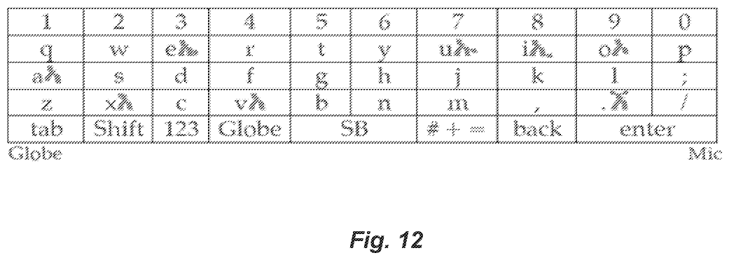

Striking keys such as “v”, “u”, “i”, “a”, “e”, “o” and “period” types shows and settles the glyphs assigned to be Ethiopic vowel glyphs such as “ [symbol] ”, “ [symbol] ”, “ [symbol] ”, “ [symbol] ”, “ [symbol] ”, “ [symbol] ”, “ [symbol] ” and “ [symbol] ” respectively (as shown in FIG. 12).

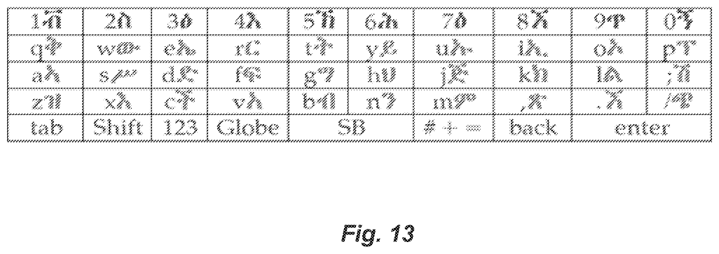

Striking the number keys such as “1”, “2”, “3”, “4”, “5”, “6”, “7”, “8”, “9” and “0” types and settles Ethiopic glyphs such as “ [symbol] ”, “ [symbol] ”, “ [symbol] ”, “ [symbol] ”, “ [symbol] ”, “ [symbol] ”, “ [symbol] ”, “ [symbol] ”, “ [symbol] ” and “ [symbol] ” respectively (as shown in FIG. 13).

Striking keys such as “1”, “2”, “3”, “4”, “5”, “6”, “7”, “8”, “9” and “O” types and settles the novel Ethiopic numeral glyphs such as “1”, “2”, “3”, “4”, “5”, “6”, “7”, “8”, “9” and “o” respectively.

Striking the keypad number keys such as “1”, “2”, “3”, “4”, “5”, “6”, “7”, “8”, “9” and “0” on computers and related gadgets types and settles the novel Ethiopic numeral glyphs such as “ [symbol] ”, “ [symbol] ”, “ [symbol] ”, “ [symbol] ”, “ [symbol] ”, “ [symbol] ”, “ [symbol] ”, “ [symbol] ”, “ [symbol] ” and “ [symbol] ” respectively.

Striking a key assigned as non-vowel glyph will result in highlighting the potential vowel forms for each language glyph or the Ethiopic selected if necessary and even show the glyphs settling each on striking the key. Example: “h”, “1”, “s”, “/” types “ [symbol] ”, “ [symbol] ”, “ [symbol] ”, “ [symbol] ”.

Striking a key assigned as non-vowel glyph results in typing and settling a glyph on striking the key. Example: “h”, “l”, “s”, “s”, “/” types “ [symbol] ”, “ [symbol] ”, “ [symbol] ”, “ [symbol] ”.

Striking the keys as in 1. above typing and settling each at zero time and also by methods such as settling each by adding unprintable glyphs such as 11743 in the codes of those that do not have to be changed.

A method whereby Ethiopic glyphs are typed from control keys such as “ctrl” arrow keys, numeric pad, etc. as first key or second.

A method whereby single glyphs rendered by a keystroke are prevented from alteration by methods such as adding non-printable codes such as 11743 to the sequences optionally while those who have to be altered do not have them.

The Ethiopic system is switched to the Latin with a keystroke and vice versa.

A method whereby the command keys such as Caps Lock, Ctrl, etc. as well as “/” and etc. and numeric pad keys render a glyph each.

A method whereby the “tab” key function as usual for tabbing or as a key or as “ [symbol] ” “tab”.

A method of typing Ethiopic on computers, notepads, smartphones and related gadgets such that some Ethiopic glyphs are typed with two keystrokes each and settled at zero time;

Striking keys such as those described in 1. a), b), c), d) and e) above twice shows, types and settle two glyphs each respectively.

Settling it at zero time as in 1. f) above shows, types and settles two glyphs also by methods such as settling each by adding unprintable glyphs such as 11743 in the codes of those that do not have to be changed.

Striking the non-vowel default keys above followed by the glyphs mentioned in 1. a, and b) results in choice of the glyphs and optional highlighting and the selected glyph showing to type and settle. Example: “h”, “l”, “s”, “/” followed by “v”, “a”, “o” “.” types and settles “ [symbol] ”, “ [symbol] ”, “ [symbol] ”, “ [symbol] ”.

Striking the non-vowel default keys above followed by the glyphs mentioned in 1. a, and b) results in choice of the glyphs highlighting and the selected glyph showing to type and settle. Example: “h”, “l”, “s”, “/” followed by “v”, “a”, “o” “.” types and settles “ [symbol] ”, “ [symbol] ”, “ [symbol] ”, “ [symbol] ”.

Striking the non-vowel default keys above followed by the glyphs mentioned in 1. a, and b) results in choice of the glyphs and the selected glyph showing to type and settle. Example: “h”, “l”, “s”, “/” followed by “v”, “a”, “o” “.” types and settles “ [symbol] ”, “ [symbol] ”, “ [symbol] ”, “ [symbol] ”.

Some keys such as “tab” could be a dead key unless followed by other glyphs that allow their typing and settling. Example: “tab” followed by “1”, “u”, “v”. “m” results in “1”, “ [symbol] ”, “ [symbol] ” and “ [symbol] ” respectively.

The shifted form of some glyphs such “3”, “e”, “f”, “k”, generate and settle glyphs such as “ [symbol] ”, “ [symbol] ”, “ [symbol] ”, “ [symbol] ”.

A method whereby some glyphs are settled by varieties of second processes such as such as adding coded for 11743, etc. without typing and rendering the second glyph.

A method whereby some glyphs are rendered with numbers as second keys. Example [symbol] with “q1” and/or “q9” and “ [symbol] ” with “q1”.

A method whereby keys such as “slash” on the keyboard and keypad render different glyphs when struck as first or second keystrokes in a two-keystroke method.

A method whereby a “shifted tab” renders “ [symbol] ”, “ [symbol] ”, and the ten Ethiopic numerals from the “Q”, “A” and “Z” rows. Long hold or populated balloons are options.

A method whereby Ethiopic glyphs are typed from control keys such as “ctrl” arrow keys, numeric pad, etc. as first or second keys.

A method whereby double striking a vowel key renders two vowels, though one is also optional.

A method whereby single glyphs rendered by two keystrokes are prevented from alteration by methods such as adding non-printable codes such as 11743 to the sequences while those who have to be altered do not have them.

A method whereby single glyphs rendered by three keystrokes are prevented from alteration by methods such as adding non-printable codes such as 11743 to the sequences optionally.

The “V” key is dead after the vowels unless the vowels are default for other keys. Example: “av” types “ [symbol] ” and “1v” types only “1” unless the “1” is assigned to “ [symbol] ” and those results in “ [symbol] ”.

The Ethiopic numbers come from the second typeface.

A method of typing Ethiopic on computers, notepads, smartphones and related gadgets such that some Ethiopic glyphs are typed with three keystrokes each and settled at zero time;

Striking shifted keys such as “V”, “U”, “I”, “A”, “E”, “O” and “>” type, show and settle the glyphs assigned to be Ethiopic vowel glyphs vowel glyphs such as “ [symbol] ”, “ [symbol] ”, “ [symbol] ”, “ [symbol] ”, “ [symbol] ”, “ [symbol] ”, “ [symbol] ” and “the eighth form of the “ [symbol] ” respectively.

Striking a glyph will result in highlighting the potential vowel forms for each language glyph type or the Ethiopic if necessary and even show the glyphs while settling it at zero time or methods such as settling it by adding nonprintable glyphs such as 11743. Example: “b”, “m”, “z”, “;” followed by “e”, “v”, “o”, “a” result in “ [symbol] ”, “ [symbol] ”, “ [symbol] ”, “ [symbol] ”.

Holding down a “tab” and striking the “1”, “2”, “3”, “4”, “5”, “6”, “7”, “8”, “9” and “0” keys type and settle the respective “1”, “2”, “3”, “4”, “5”, “6”, “7”, “8”, “9” and “0” glyphs though the default assignments on the number keys is not numbers. A depressed “ [symbol] ” “tab” is not the same as striking the “tab” key and its usage is like the “shift” key.

Striking a shifted default key followed by the non-vowel keys assigned to be key types, shows and highlight the varieties to settle. Example: “B”, “M”, “Z”, “:” followed by “e”, “v”, “o”, “a” settles “ [symbol] ”, “ [symbol] ”, “ [symbol] ”, “ [symbol] ”.

A “tab tab” striking followed by the non-vowel default glyphs type and settle the Meen Ethiopic glyphs that can be considered the ninth order. Example:

The ninth form of the Ethiopic or the Meen glyphs are typed with the default and “O”. Example: “nO” types “ [symbol] ” and “pO” types “ [symbol] ”.

The method whereby keys such as “tab” are utilized as third shift key and such that “ [symbol] ” “tab” types a glyph while holding down the tab key alone.

A method whereby three keystrokes such as “tab tab/” render “ [symbol] ” and settle Ethiopic ninth order glyphs. Those in shifted positions are typed with the default and “O”. Example: “ [symbol] ” with “dO”.

A method whereby programming to render glyphs with or without timeout is mixed.

A method whereby keys such as “slash” on the keyboard and keypad render different glyphs.

A method whereby some glyphs are rendered with numbers as third keys. Example [symbol] with “q1” and/or “q9” and “ [symbol] ” with “q1”.

A method whereby Ethiopic glyphs are typed from control keys such as “ctrl” arrow keys, numeric pad, etc. as first, second or third keys.

Three keystroke includes “shift Period one” typing. Holding down the “shift” and typing the “1” is the same as “shift 1” and thus types the Ethiopic space mark or “ [symbol] ” and its advantage is to make typing simple by ignoring the unnecessary strokes.

The third vowels can be typed with double striking the sixth orders.

Other methods.

A method whereby an Ethiopic glyph is typed with more than one method. Example “ [symbol] ” can be typed with “a”, “4a” and “xa” or “av”.

A method whereby keys such as “tab” are utilized as third shift key and such that depressed “tab” followed by 1″ types “1”.

A method whereby the Saint Yared's notations are typed with the “j” followed by the numbers.
A method whereby some glyphs are settled by varieties of second processes such as adding coded for 11743, etc. to two keystrokes.
A method whereby some glyphs are rendered with numbers as second keys. Example [symbol] with “q1” and/or “q9” and “ [symbol] ” with “q1”.
A method whereby the glyphs are type in reverse as an option, Example “aT” for “ [symbol] ” when interference is avoided.
A method whereby keys such as “slash” on the keyboard and keypad render different glyphs when struck as first or second keystrokes in a two-keystroke method.
A method whereby a “shifted tab” renders “ [symbol] ”, “ [symbol] ”, and the ten Ethiopic numerals from the “Q”, “A” and “Z” rows. Long hold or populated balloons are options.

The “V” key is dead when typed as first entry. It types “ [symbol] ” on double striking it and “ [symbol] ” on “v” followed “V” because the key is also assigned to be an Ethiopic first order vowel.

A method where keys render Ethiopic by inactivating the Latin glyphs.

A period types the Ethiopic period while a double strike types Latin period. Period followed by 1 type 1 for the symbol series while is followed by numbers. they type period followed by a minus. “1” followed by period also types minus.

Single glyphs generated by two keystrokes could also be settled by 11743.

“Period a” types “ [symbol] ”, though it interferes with the second keystroke of the period. Thus, one option is to avoid it and type the “ [symbol] ” with “ctrl a”, “a ctrl”, as an option.

Virtual abbreviated or non-abbreviated keyboarding is modification to include the current novel methods in ten or more glyphs per row QWERTY type and other layouts.

The use of period as an optional eighth and ninth vowels as well as vowels for use with “tab”. “tab tab a” types “ [symbol] ”.

In a virtual computer and smartphone keyboards, the extra keys could be assigned to extended ASCII characters to render regular characters.

A virtual row of ten or more keys can be added to the bottom to maintain the seven keys of the “z” row.

Double striking these “a” still does not change anything. Double striking the “a” could type “ [symbol] ”. [symbol] can be assigned to numbers and/or their shifted positions.

Programing includes incorporation or removal of the English part of the encoding.

There are times when four keystrokes per glyph are possible though this are avoided, though included in the claim.

A method whereby programming to render glyphs with or without timeout and other features are optionally mixed.

Virtual abbreviated or non-abbreviated keyboarding is modification to include the current novel methods in ten or more QWERTY type and other layouts for smartphones and related gadgets as follows:

The basic principles are as in the computer layout except that similar forty keys are utilized. Example: “1”, “q”, “a”, “z” rows of ten each.

The default keys type one glyph each and they are settled at zero time.

The shift key is presented by two keystrokes to get to the glyphs. Example: “B” for “ [symbol] ”.

Other than the default that in the past was the sixth order only and the vowels doubled as characters and vowels, seven keys became dedicated eight vowels. Example: “vuiaeo.O” for “ [symbol] . Double tab is also for the ninth vowel with the shifted ninth glyphs as in “tab tab t” for “ [symbol] ”.

The use of the same principle in the Hele layout in the computer environment with relevant modifications.

The method whereby on-screen keyboard is used. Keys such as “minus” can function simulating full screen.

use of the same principle in the Hele layout in the smartphone environment with relevant modifications.

a) The method whereby on-screen keyboard is used. Keys such as “minus” can function simulating full screen.

b) In virtual keyboard the defaults are typed with a keystroke each and the vowel forms take two.

c) This ten-key row can be improved for the better with the 11.

d) Additional keys can be added at the bottom.

e) Example vowels such as relevant “ [symbol] ” can be added at the bottom

A method where three keystrokes render a glyph and an example is “Ta” for “ [symbol] ”.

A method whereby keys such as “tab” are utilized as third shift key and such that depressed “tab” followed by “1” types “1”. A non-depressed tab acts as a dead key as an option. A depressed “tab” followed by a “q” generates “ [symbol] ”.

A non-depressed “tab” generates a deferent glyph when followed by another glyph. Example “tab q” generated “ [symbol] ” while “q tab” generates “ [symbol] ”.

One or more Amharic typewriter glyphs and similar pieces are ligated to look like the Amharic alphabet while being settled.

The use of the extended characters to associate with virtual keys in this novel keyboarding.

The method could utilize methods described earlier such as long hold, timeout as well as settling popup lists at zero time with or without the glyphs.

A method whereby “B1” or “B=” types [symbol] making it suitable for smartphones and computer keys.

A method whereby “tab tab” and a third keystroke render a glyph.

A method whereby a “#−=” key on smartphone brings up third tier order glyphs so that the third press chooses the glyph. Example “#−=” key “du” renders “ [symbol] ”.

A novel method of generating different glyphs by typing a glyph from striking a “tab” key followed by any key as opposed to generating a different glyph by using a depressed “tab” followed by any key.

A method whereby Ethiopic glyphs are typed from control keys such as “ctrl” arrow keys, numeric pad and second glyphs such as “/*−+.” as first or second keys.

A method whereby the Ethiopic alphabetic numbers are typed from the “tab” key followed by the keys on the “Q” and “A” rows and the Ethiopic numerals by the “Z” rows of QWERTY or other layouts.

A method whereby tilde and numbers render Ethiopic symbols such as Ethiopic copyright or other rows.

A method whereby “ [symbol] ” is typed with “z”, “ [symbol] ” with “Z”, “ [symbol] ” with “z6” and “ [symbol] ” with “Z6” and “right fn” or vice versa. It can also be typed with any of the second symbols on the numeric keypad and the vowels. Example: “ [symbol] ” with “L”.

A method whereby the glyphs are typed in reverse as an option, Example “aT” for “ [symbol] ”. “ [symbol] ” can be typed with “aaq”.

A method whereby some English glyphs are typed with fewer keystrokes such that the “#+=” keyboard is accessed from the default keyboard.

a) Such that pressing this new icon on the default keyboard brings up the fourth “#+=” keyboard and the symbols are typed with two keystrokes instead of three.

b) The keyboard remains open after a glyph from there is typed.

c) From there the “123” and “ABC” keyboard are also each accessed by striking the respective key.

A method whereby some Ethiopic glyphs are typed by simultaneous pressing of three keys. Example. “tab/1” or “tab q” types “ [symbol] ”.

A method whereby some English alphabets are typed from within the Ethiopic keyboard with two keystroke each. Example “-a” for “a” and “+a” for “A” specially from those on the numeric pad. Could include symbols such as trademark in English

An Ethiopic dedicated publisher (such as EthioSuite) with English and different configuration with or timeout various layouts including custom.

A method whereby balloons and pop ups appear with different glyphs while settling the default with a keystroke or its shifted form in virtual keyboards. These glyphs are settled because of the same principles.

An example method with Hele layout other than the QWERTY discussed above where additional rows are added or the function keys are utilized in addition to the numeric keys to make four rows of vowels.

The different 13 language character sets are progressively added to accommodate all Ethiopic from a single default keyboard without interference.

A method whereby groups of ten and similar glyphs are assigned to open shifted position keys such as W, R, Y, J, L, M, period, slash and even the apostrophe. The varieties can be rendered with the extended vowels, shifted vowels or numbers with or without the involvement of the additional programmable symbols on the numeric keypad.

It is possible to settle glyphs with secondary steps that vary from adding a space to typing the following glyph as well as even saving a document.

One of the prerequisites of the Ethiopic system is to deactivate some Latin keys first and it is thus a new claim. Default settlement with a keystroke includes the Ethiopic “a” series, the command keys and even the symbols on the numeric pad.

Use of GeezEdit with its patented or current methods in different apps including EthioSuite. On-screen keyboard is another claim while by default the EthioSuite works with the methods described in this patent and also on-screen keyboard.

Stress and stretch marks, tones and relevant features added. “ [symbol] ” can be typed with “r4”. “Period tab” types “ [symbol] ” or “caps lock” (8682). “-1” could type “1”. Keystrokes can be changed or modified.

Three keystroke includes “shift Period one” typing. Holding down the “shift” and typing the “1” is the same as “shift 1” and thus types the Ethiopic space mark or “ [symbol] ”. Another claim is to type “1” with “tab tab 1”.

For time out to work the “no timeout” should not be ticked and the map should indicate “false”.

In some embodiments, the depression of one or more keys during subsequent keystrokes may result in the generation and rendering of different characters or glyphs. For example, the user may hold the “shift” and “tab” keys and a number key (e.g., the number “1” on the keyboard), where all the three keys are simultaneously depressed. In this case, a processor of the device connected to the keyboard may be programmed to generate a first character when the processor determines that all three keys are simultaneously depressed. In some embodiments, the user may be able to program the processor and/or keyboard through a user interface (e.g., a display on a computer), such that the user can choose the character rendered when all three keys are simultaneously depressed. The resulting character may be different when the user does not press all three keys simultaneously. For example, the user may press the shift and tab” keys, release the “shift” and “tab” keys, and then press the number “1”, resulting in a different character. In one embodiment, the set of characters associated with the language in which the user desires to type may be captured using a maximum of 26 keys on the keyboard (e.g., A-Z on a QWERTY keyboard) as well as a set of number keys (such as the number row and/or a numeric keypad of the QWERTY keyboard).

In some embodiments, a set of keystrokes (or more generally, a set of keys on the QWERTY keyboard) are associated with a set of vowels. For example, and as discussed above, the v, u, i, a, and o keys may be associated with a set of vowels in the phonetic language that the QWERTY keyboard is used to type. Similarly, another, different set of keystrokes (or more generally, another different set of keys on the QWERTY keyboard) may be associated with a set of consonants. As a result, the user of the QWERTY keyboard may be able to type sets of constants and vowels using different sets of keystrokes. In some embodiments, the user may be able to program each key or keystroke to correspond to a desired vowel or consonant, enabling the user to customize his typing experience.

In some embodiments, the user of the QWERTY keyboard may be able to switch between different phonetic languages using one or more keystrokes. For example, the QWERTY keyboard may enable a user to type characters or glyphs associated with a first language while the QWERTY keyboard is in a first mode. The user may be able to then switch the QWERTY keyboard into a second mode by pressing one or more keys on the QWERTY keyboard. While in the second mode, the same set of keystrokes input by the user may result in the computer rendering different characters or glyphs, enabling the user to type in multiple different languages.

In some embodiments, reverse typing is possible and also explained as in typing a glyph such as “ [symbol] ” with “Ta” or “at” and even different glyphs. An example where the second method may not work is because the “a” to type “at” interferes with a previously typed default or shifted default by becoming a vowel. Toggling is avoided for a different reason.

In some embodiments, Caps Lock is avoided in the sequence typing because its use requires changing the registry and that interferes with typing English, though English can be typed from the Ethiopic keyboard with two keystroke each by assigning a keystroke for small and another one for capitals. An example is to activate English with a key such as “'” and “-” with a keystroke each. Typing “′nm” renders “nm” while “-nm” types “NM”.

In another example, it is more intuitive to assign the “ [symbol] ” key to the shifted position of the “ [symbol] ” on the “K” key as those series are related. This is okay with Amharic while it requires introduction of exceptions such as typing “ [symbol] ” and/or “ [symbol] ” with combinations such “k66”, “k6k”, “k\hat{ }”, “K6”, etc. In spite of these, the “ [symbol] ” key may be associated with the “L” key, and this is an example of options that can be changed if necessary and make other keyboarding adjustments for different layouts. Such typing and even involvement of others such as long hold should not be considered as oversight or exclusion from the claims. This is because the combinations and permutations involving three keys and the rest of the keys is high.

Any of the steps, functions, and operations discussed herein can be performed continuously and automatically.

The exemplary systems and methods of this disclosure have been described in relation to typing characters on a keyboard. However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should, however, be appreciated that the present disclosure may be practiced in a variety of ways beyond the specific detail set forth herein.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

A number of variations and modifications of the disclosure can be used. It would be possible to provide for some features of the disclosure without providing others.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the embodiments with reference to particular standards and protocols, the disclosure is not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The present disclosure, in various embodiments, configurations, and aspects, includes components, methods, processes, systems and/or apparatus substantially as depicted and described herein, including various embodiments, subcombinations, and subsets thereof. Those of skill in the art will understand how to make and use the systems and methods disclosed herein after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease, and/or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

The phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an embodiment that is entirely hardware, an embodiment that is entirely software (including firmware, resident software, micro-code, etc.) or an embodiment combining software and hardware aspects that may all generally be referred to herein as a “circuit,” “module,” or “system.” Any combination of one or more computer-readable medium(s) may be utilized. The computer-readable medium may be a computer-readable signal medium or a computer-readable storage medium.

A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including, but not limited to, wireless, wireline, optical fiber cable, RF, etc., or any suitable combination of the foregoing.

The terms “determine,” “calculate,” “compute,” and variations thereof, as used herein, are used interchangeably and include any type of methodology, process, mathematical operation or technique.

What is claimed is:

1. A method for generating a set of characters of a phonetic language using key presses inputted on a QWERTY keyboard, the method comprising:
receiving, at the QWERTY keyboard, a first keystroke;
receiving, at the QWERTY keyboard, a second keystroke;
determining whether a first keystroke was pressed during the second keystroke;
generating, when the first keystroke of the QWERTY keyboard was pressed during the second keystroke, a first character;
generating, when the first keystroke of the QWERTY keyboard was not pressed during the second keystroke, a second character different from the first character; and
rendering the first character and the second character to a display,
wherein each character of the set of characters can be generated using a maximum of three keystrokes.

2. The method of claim 1, wherein a first set of keystrokes on the QWERTY keyboard is associated with a set of vowels.

3. The method of claim 2, wherein a second set of keystrokes on the QWERTY keyboard is associated with a set of consonants.

4. The method of claim 1, further comprising:
enabling the QWERTY keyboard to generate the set of characters in the phonetic language while the QWERTY keyboard is in a first mode; and
enabling the QWERTY keyboard to generate a second set of characters in a second phonetic language while the QWERTY keyboard is in a second mode.

5. The method of claim 4, wherein the QWERTY keyboard is switchable between the first mode and the second mode with at least one keystroke.

6. The method of claim 1, wherein the QWERTY keyboard is a virtual keyboard or a physical keyboard.

7. The method of claim 1, wherein the set of characters can be generated using a maximum of 26 keys on the QWERTY keyboard and the ten number keys.

8. The method of claim 1, wherein at least one character of the set of characters can be generated by the QWERTY keyboard using two or more different combinations of keystrokes.

9. A method for generating a set of characters of a phonetic language using key presses inputted on a QWERTY keyboard, the method comprising:
receiving, at the QWERTY keyboard, a first keystroke;
receiving, at the QWERTY keyboard, a second keystroke;
receiving, at the QWERTY keyboard, a third keystroke;
determining whether the first keystroke of the QWERTY keyboard kept a first key depressed during the second keystroke;
generating, when the first key of the QWERTY keyboard was depressed during the second keystroke, a first character;
generating, when the first key of the QWERTY keyboard was not depressed during the second keystroke, a second character different from the first character; and
rendering the first character or the second character to a display,
wherein each character of the set of characters can be generated using a maximum of three keystrokes.

10. The method of claim 9, wherein a first set of keystrokes on the QWERTY keyboard is associated with a set of vowels.

11. The method of claim 10, wherein a second set of keystrokes on the QWERTY keyboard is associated with a set of consonants.

12. The method of claim 9, further comprising:
enabling the QWERTY keyboard to generate the set of characters in the phonetic language while the QWERTY keyboard is in a first mode; and
enabling the QWERTY keyboard to generate a second set of characters in a second phonetic language while the QWERTY keyboard is in a second mode.

13. The method of claim 12, wherein the QWERTY keyboard is switchable between the first mode and the second mode with at least one keystroke.

14. The method of claim 9, wherein the QWERTY keyboard is a virtual keyboard or a physical keyboard.

15. The method of claim 9, wherein the set of characters can be generated using a maximum of 26 keys on the QWERTY keyboard and the number keys.

16. The method of claim 9, wherein at least one character of the set of characters can be generated by the QWERTY keyboard using two or more different combinations of keystrokes.

17. A system, comprising:
a QWERTY keyboard;
a processor coupled to the QWERTY keyboard; and
a memory coupled to the processor and storing instructions thereon that, when processed by the processor, cause the processor to:
determining whether a first keystroke kept a first key pressed during a second keystroke;
generate, when the first key of the QWERTY keyboard was pressed during the second keystroke, a first character;
generate, when the first key of the QWERTY keyboard was not pressed during the second keystroke, a second character different from the first character; and
render the first character or the second character to a display,
wherein each character of a set of characters of a phonetic language can be generated using a maximum of three keystrokes.

18. The system of claim 17, wherein the QWERTY keyboard is a virtual keyboard or a physical keyboard.

19. The system of claim 17, wherein the set of characters can be generated using a maximum of 26 keys on the QWERTY keyboard and the ten number keys.

20. The system of claim 17, wherein at least one character of the set of characters can be generated by the QWERTY keyboard using two or more different combinations of keystrokes.
